(19) United States
(12) Patent Application Publication
(10) Pub. No.: US 2005/0084054 A1
(43) Pub. Date: Apr. 21, 2005

(54) Coulomb force neutralized fusion reactor

(76) Inventor: Dennis L. Franz, Selah, WA (US)

Correspondence Address: STRATTON BALLEW, 213 S 12TH AVE, YAKIMA, WA, 98902, US

(21) Appl. No.: 10/666,800

(22) Filed: Sep. 18, 2003

(51) Int. Cl. G21B 1/00

(52) U.S. Cl. 376/121

(57) ABSTRACT

A fusion reactor that has a multiple of fuel rings per second that spin in a spiral form. The fusion reactor produces a sustainable, controlled fusion reaction that produces more energy than it uses. The reactor employs a system of resonant magnetic fields that control the direction of the fuel particles' momentum and polarity, and neutralizes the interactive forces of the fuel particles linear Coulomb repulsions. The rotating ring has a geometric rate of radius reduction for ring stability and efficient fusion reaction. Preferably, a stream of lithium nuclei are utilized as fuel. In merging lithium nuclei within the controlled spiral of a resonant magnetic field, positive alpha charges are produced. These high-energy alpha charges are then directed into a generator for the purpose of pumping electrons to produce electricity.

### TECHNICAL FIELD

The invention relates to a method and apparatus for producing a sustainable, controlled fusion reaction, and more particularly to an electricity producing reactor employing a system of resonant magnetic fields, which control the direction of the momentum and polarity of fuel particles, to sustain a nuclear fusion reaction. The present invention preferably utilizes a stream of lithium nuclei as fuel. In merging lithium nuclei within the controlled spiral of a resonant magnetic field, overcoming the Coulomb repulsions of the particles, positive alpha charges are produced in a fusion reaction. These high-energy alpha charges are then directed into a generator for the purpose of pumping electrons, to produce electricity.

### BACKGROUND OF THE INVENTION

The classical approach for achieving controlled nuclear fusion has been through various super-thermal mechanisms, which include Tokomak, Mirror, and Inertial Confinement methods. Instead of efficiently generating a net surplus of energy, producing small bursts of energy at a great energy cost has been the disappointing result of these conventional approaches. These thermal mechanisms attempt to overcome the Coulomb repulsion of the participating nuclei at a close enough distance to achieve fusion, with enough energy in terms of momentum of the nuclei at a radially accelerated state, where the strong force dominates over electromagnetic repulsion.

The illusive net efficiency goal of these conventional mechanisms is determined and defined by the well known “Lawson Criterion.” Under the Lawson Criterion, the simple purpose of an energy producing system is to produce a net gain in energy. The nuclear process of fusion has the enticing possibility of being a most efficient, flexible, and cost-effective method of energy production. However, even at the relatively low energy value for the deuterium-tritium thermal approach, the goal of an energy surplus in a continuous reaction has not been forthcoming.

Several foundational assumptions arise from a review of the field of controlled nuclear fusion. One area of such conventions or conclusions, concerns the physical properties of a plurality of fuel nuclei and their collective arrangements. These physical properties and arrangements have been determined to be set, and cannot be manipulated. This severely limits the design alternatives and increases the cost and complexity of conventional fusion systems.

One specific commonly held assumption is that the nuclei involved in fusion reactions cannot be organized in any way other than the random thermal gyrations of position as presented in a plasma. This plasma is contained in a magnetic field or is created from a frozen base that is converted to the plasma state in a short time.

Another assumption is that the tremendous Coulomb repulsion between the nuclei cannot be altered. Combining these two assumptions and building a design within their confinement creates a challenge that is apparently insurmountable. The Coulomb repulsion in a plasma is additive with respect to the number of nuclei and density of the plasma. Typically, the plasma is contained by a magnetic field of some optimum shape. This field has an upper limit in Tesla, or magnetic flux density, defined by limits of ampacity and conductivity. The density of magnetic flux defines the density of the plasma contained in the field, relative to the temperature and charge neutrality of the plasma.

To these above assumptions, the concepts of “mean-free-path” and the “energy of the reaction products” can be added. To have a plasma fuse efficiently with a positive net energy gain, the density must increase beyond present abilities in building a strong enough magnetic field. Furthermore, if a field to do this could be built, the fusion products would be so numerous and energetic that the containment vessel and energy recovery system would melt.

Yet another assumption is that the “cross section,” which is the probability of reaction between two particles cannot be changed, because of the mass to charge ratio. Therefore, no fuels other than a hydrogen isotope can be considered. Again, this limits the design possibilities because of its high energy yield, but more importantly because the energy of reaction is carried away by the neutrons produced. The energy recovery system concepts borrowed from fission technologies need neutrons to be viable, but at a severe price. These fusion neutrons from hydrogen isotopes are far more energetic than those produced by the fission reactions and therefore their ability to alter the nuclei of the surrounding environment is substantial.

It is tempting in the design and construction of a fusion system to disregard the principle of uncertainty with respect to particle velocity and position. To do this, within the parameters of the dimensions typically employed, is to disregard reality. Truth of reality in any such design must use the certainty characteristics of the nuclei which are charge, frequency, spin and relative variable mass.

A preliminary undertaking of the present invention is to re-examine, through documented physics experience, these conclusions that are assumed to be unalterable. If progress can be made in this regard, controlled fusion may become feasible and beneficial. Given a proper, low cost and efficient design that could be scaled to meet localized power needs, the fusion process has the ability to greatly simplify the power grid. Centralized power generation plants might be eliminated, and so eliminating the need for high tension, high voltage power lines. The proper, smaller scale fusion design, gives power independence to large buildings, small towns, cities, ships, trains, and unknown independent future needs. This ideal fusion design would result in an environmentally clean process with no neutron radiation, no combustion gases, and no large facilities or infrastructure.

To meet this goal, the fusion fuel must be inexpensive and abundant. There are many interesting, light element fusion reactions. These light element reactions have a range of atoms from hydrogen through carbon, with reactant products being the positron through oxygen. So far, the most meaningful choice has been the use of deuterium and tritium to yield helium and a very energetic neutron. This reaction has been typically chosen because the thermal mechanism for the reaction is at its lowest value.

There are two basic ideals or goals, for improving existing institutional fusion methods. The first goal is a system that is operationally viable. This means having a system with the ability to produce a net surplus of energy, continually. The second goal is a system that is manageable, which means having a system that can be small, affordable, clean, and easy to maintain.

The choice of fusion fuel and therefore the fusion reaction must reflect these goals and ideals. In order for the system to be manageable, it must be clean. Therefore, as a fundamental premise, the reaction cannot produce neutron radiation. Although a neutron flux gives a method of energy recovery, it also presents the need for extensive provisions to handle irradiated structures, coolants and heat transfer media. This is particularly true for the deuterium-tritium reaction and the deuterium-deuterium reaction. Both are championed by conventional institutional development in fusion, and both produce undesirable high-energy neutrons.

The present invention addresses these daunting issues, which have plagued the task of developing a safe, scalable and efficient fusion reactor with the ability to produce a net positive power flow. The invention will be better understood by reference to the following detailed description, taken in conjunction with the accompanying figures, tables, equations and drawings.

### BRIEF DESCRIPTION OF DRAWINGS

FIG. 1 is a diagram of “A Pre-Reactor,” according to an embodiment of the invention;

FIG. 2 is a diagram of “Coulomb Forces Across a Ring for a Pair of Particles,” according to an aspect of the invention;

FIG. 3 is a diagram of “Coulomb Forces Across a Ring for a Plurality of Particles,” according to an aspect of the invention;

FIG. 4 is a diagram of “A Counterbalance of Coulomb Repulsion in a Magnetic Field,” according to an aspect of the invention;

FIG. 5A is a diagram of “A Non-Uniform Magnetic Field Pair,” according to an aspect of the invention;

FIG. 5B is a diagram of “A Multiple of Accelerator Coil Pairs,” according to an aspect of the invention;

FIG. 6 is a diagram of a “Vector Representation of Particle Forces Along a Compressor Solenoid Field Line,” according to an aspect of the invention;

FIG. 7 is a diagram of a “Compressor Radial Field,” according to an aspect of the invention;

FIG. 8 is a diagram of a “Compressor Radial Field Coil,” according to an aspect of the invention;

FIG. 9 is a diagram of a “Compressor Radial Field,” according to an aspect of the invention;

FIG. 10A is a diagram of a “Compressor Radial Additive Vector,” according to an aspect of the invention;

FIG. 10B is a diagram of a “Compressor Radial Additive Vector,” according to an aspect of the invention;

FIG. 11 is a diagram of a “Compressor Radial Coil Vector,” according to an aspect of the invention;

FIG. 12A is a diagram of “Compressor and Solenoid Radial Orbital Forces Vectors at the Top of the Compressor,” according to an aspect of the invention;

FIG. 12B is a diagram of a “Vector Sum of Compressor and Solenoid Radial Orbital Forces at the Top of the Compressor,” according to an aspect of the invention;

FIG. 13A is a diagram of “Compressor and Solenoid Radial Orbital Force Vectors at the Bottom of the Compressor,” according to an aspect of the invention;

FIG. 13B is a diagram of a “Vector Sum of Compressor and Solenoid Radial Orbital Forces at the Bottom of the Compressor,” according to an aspect of the invention;

FIG. 14 is a diagram of “Unequal Rates of Change for Radial and Solenoid Fields,” according to an aspect of the invention;

FIG. 15 is a diagram of “Force Vectors Acting from a Circular Field,” according to an aspect of the invention;

FIG. 16 is a diagram of “Force Vectors Acting from a Circular Field,” according to an aspect of the invention;

FIG. 17 is a diagram of a “Vector Sum of Forces,” according to an aspect of the invention;

FIG. 18 is a diagram of “Magnetic Fields Acting Upon Particles,” according to an aspect of the invention;

FIG. 19A is a diagram of “Accelerator Force Vectors,” according to an aspect of the invention;

FIG. 19B is a diagram of a “Vector Sum of Orbital Forces,” according to an aspect of the invention;

FIG. 20 is a diagram of “Force Vectors Acting Upon Particles,” according to an aspect of the invention;

FIG. 21 is a sectioned side view of a “Reactor System,” according to a preferred embodiment of the invention;

FIG. 22A is a partially sectioned top view of a “Compressor Solenoid and Radial Coil,” according to a preferred embodiment of the present invention;

FIG. 22B is a partially sectioned side view of a “Compressor Solenoid and Radial Coil,” according to a preferred embodiment of the invention;

FIG. 23 is a partially sectioned side view of a “Composite Reactor System,” according to a preferred embodiment of the invention;

FIG. 24 is a sectioned side view of a “Solenoid Field,” according to a preferred embodiment of the invention;

FIG. 25 is a side view diagram of a “Radial Field,” according to a preferred embodiment of the invention;

FIG. 26 is a side view diagram of a “Central Conductor,” according to a preferred embodiment of the invention;

FIG. 27 is a top view diagram of a “Central Conductor,” according to a preferred embodiment of the invention;

FIG. 28A is a top view diagram of an “Accelerator Radial Coil Pair,” according to an aspect of the invention;

FIG. 28B is a edge view diagram of an “Accelerator Radial Coil Pair,” according to an aspect of the invention;

FIG. 29 is a side view of a “Circular Field,” according to a preferred embodiment of the invention;

FIG. 30 is a side view of a “Ring chamber,” according to a preferred embodiment of the invention;

FIG. 31 is a top view of an “Accumulator,” according to a preferred embodiment of the invention;

FIG. 32 is a diagram of “Accumulator Fields,” viewed along section line 32-32 of FIG. 31, according to a preferred embodiment of the invention;

FIG. 33A is a sectioned side view of a “Guiding Center Drift,” according to a preferred embodiment of the invention;

FIG. 33B is a detail of a “Guiding Center Drift,” as referenced to circled detail 33B of FIG. 33A, according to a preferred embodiment of the invention;

FIG. 33C is a top view of a “Guiding Center Drift,” according to a preferred embodiment of the invention;

FIG. 33D is a sectioned side view of a “Guiding Center Drift,” according to a preferred embodiment of the invention;

FIG. 34A is a top view diagram of a “Density Coil Pair of a Reaction Cyclotron Stabilizer,” according to a preferred embodiment of the invention,

FIG. 34B is a top view diagram of a “Reaction Accelerator Pair of a Reaction Cyclotron Stabilizer,” according to a preferred embodiment of the invention;

FIG. 35 is a sectioned top view of a “Compressor,” according to a preferred embodiment of the invention.

FIG. 36A is a partially sectioned top view of a “Generator,” according to a preferred embodiment of the invention; and

FIG. 36B is a partially sectioned side view of a “Generator,” according to a preferred embodiment of the invention.

### DETAILED DESCRIPTION OF SPECIFIC EMBODIMENTS

The present invention provides a method and apparatus for a fusion reactor that employs a system of resonant magnetic fields to control the directional momentum and polarity of fuel particles in a spiral path for a nuclear fusion reaction. In a preferred embodiment of the present invention, the reactor system brings together two lithium nuclei in a resonant magnetic field environment that neutralizes or overcomes the Coulomb repulsions between the particles, to produce positive, alpha charges. These high-energy alpha charges are then directed to pump electrons, and thereby produce electricity.

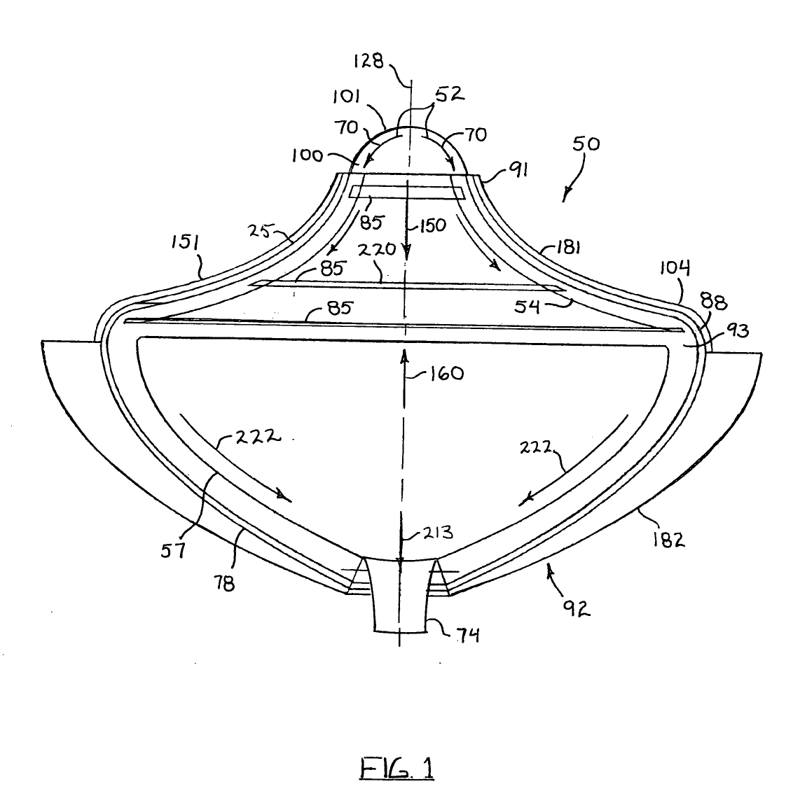

Components and aspects of a Coulomb force neutralized reactor system 45, according to a preferred embodiment of the present invention, are shown in FIGS. 1 through 361, herein. FIG. 1 shows a pre-reactor 50, which is a primary component of the Coulomb force neutralized reactor system. The reactor receives a fuel stream 52 into a three dimensional magnetic field environment (B). Within the magnetic field, the fuel stream forms a fuel ring 85, as shown in FIG. 1. With the aid of the magnetic field, the pre-reactor functions to first accelerate and then concentrate the fuel stream within the fuel ring, facilitating a nuclear fusion reaction, as discussed in detail herein, beginning with premise considerations, as follows:

I. The Selection of The Lithium Reaction

Even at the relatively low energy value for the deuterium-tritium thermal approach to nuclear fusion, the goal of an energy surplus in a continuous reaction has not yet been achieved by modern science. Additionally, this conventionally chosen, thermal approach or “thermal drive mechanism”produces high-energy neutrons, which are not acceptable by-products. Therefore, a different drive mechanism for the fusion reaction, rather than the conventional thermal drive mechanism, must be created. As is the case with the thermal drive mechanism, the mechanism helps determine the fuel choice.

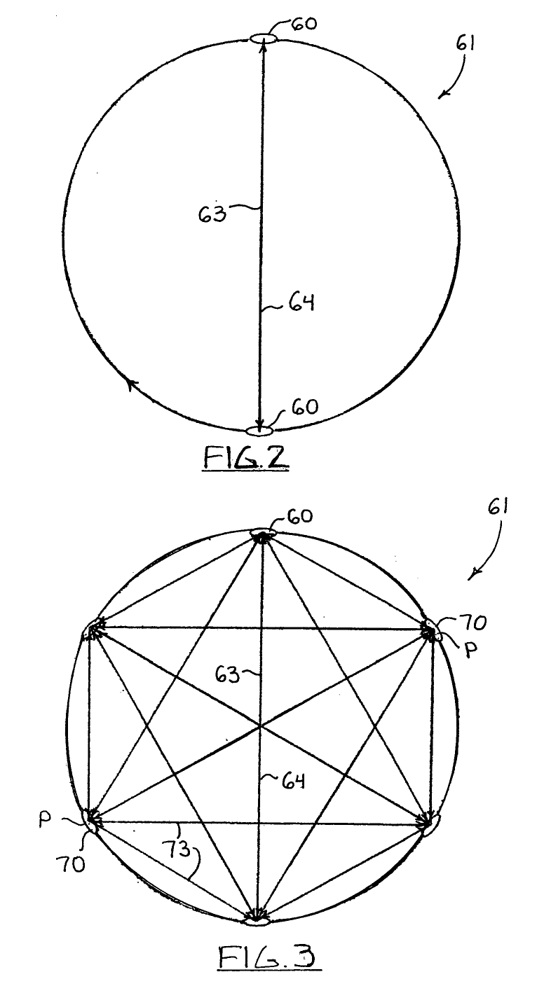

Because the Coulomb repulsive forces at fusion densities are so great, there must be a way to remove or cancel, all or part of them. Vectors, as graphical depictions of forces, denote sums relating to magnitude and direction. To cancel its components, a force must be positioned so that the sum of its component magnitudes is zero. Classically, if there are two equal charges 60 of the same mass rotating in equilibrium in a uniform magnetic field (B), they form an “idealized ring” 61, which is the pattern formed by the particles' classical orbits in a ring shaped, uniform magnetic field. These two equal charges will remain equidistant from each other, as shown in FIG. 2. The inward magnetic field force of charge rotation 63 cancels an outward Coulomb repulsion force 64.

If more than the two equal charges 60 are added to the idealized ring 61, another force cancellation mechanism operates between individual nuclei of fuel. As shown in FIG. 3, a charge 70, or particle (P) of equal charge, can be added to the ring, resulting in a side to side force. This side to side force is a Coulomb repulsive force 73 between neighboring charges. Throughout the present description of the subject invention, the term “charge” is employed synonymously with the term “particle,” in that the particles utilized for the present invention are ionized or “charged.” Additionally, throughout the present description of the subject invention, the term “nuclei” is employed synonymously with the term “particle,” and charge, in that in a preferred embodiment of the present invention, an atom is ionized to remove all electrons, to form a “nucleus,” comprising neutrons and protons, the ionized atom's nucleus being the pre-processed fuel of the fusion reactor of the present invention. Furthermore, the present invention has potential applications that may well employ particles that are not simply or purely nuclei but should be understood that the present discussion applies to these alternative embodiments.

Again referring to FIG. 3, with three or more charges 70 in this rotating system, the geometric shape of the system is again, that of the ring 61. This idealistic ring is a two dimensional, classical system, which approximates containment method within the fuel ring 85, employed for the fuel stream 52 in the pre-reactor 50 of the present invention, as shown in FIG. 1. The pre-reactor, which includes an accelerator 91 and a compressor 92, preferably employs the “ring-shaped drive mechanism,” referred to herein as the fuel ring.

In the idealized ring 61, as shown in FIG. 3, the Coulomb repulsive forces 73 are canceled around the ring and are positively cumulative across the ring, balanced by the inward magnetic field force of charge rotation 63. This delicate balance of charges also provides numerous opportunities to control physical variables, as will be discussed in the following sections.

II. Design of the Fuel Ring

With the ring shaped drive mechanism of the present invention, or fuel ring 85, the most preferred choice of viable fuel elements narrows. The rotating fuel ring geometry means that the mass and charge of all the nuclei in the ring must be the same. There are only four realistic choices to be considered. These are the ¹H+¹H→²D+e⁺ reaction, ²D+²D→³He+¹n reaction, the ³He+³He→⁴He+2¹H reaction, and the ⁶Li+⁶Li →3⁴He reaction. The proton-proton reaction produces only 1.4 MeV, which is comparatively low. The ²D+²D reaction has already been eliminated because it produces high-energy neutrons. The ³He+³He reaction is fine in other places besides earth. Although our galaxy has an abundance of ³He, as does our moon, on earth there is only a minute amount. Through elimination, the choice of fuel is ⁶Li.

As discussed above, the ⁶Li+⁶Li reaction produces ⁴He. Without electrons, ⁴He is the “alpha particle,” which carries a positive charge and no free neutrons, at the point of the fusion reaction. These alpha particles are very energetic and carry 20.5 MeV. With this fuel and mechanism arrangement, real efficiencies of energy production can be achieved. This ⁶Li fuel is abundant and relatively easy to collect, and for the most part, obtained from seawater. Only one fuel component is required, and the mechanism's structure can be relatively small in size, as compared to conventional fusion reactor systems. There are no neutrons produced, and with the energetic positively charged alpha particles, electrons can be pumped directly without the need for turbines and standard generators.

In this “Coulomb Force Neutralized Fusion Reactor” description, ⁶Li is designated in several ways. ⁶Li is an isotope of lithium (Li) that has three neutrons and three protons in its nucleus. Surrounding its nucleus the Li atom has three electrons. In the present description, ⁶Li has the designation of an atom, a nuclei, a particle, an ion, or a charge, depending on the dominant characteristic interacting in a particular environment. For example, ⁶Li is designated as a charge interacting with a magnetic field environment or an ion in the accelerator environment.

To best understand the present invention, the idealized ring 61 approximation, as shown in FIG. 3, is again utilized for discussion. The idealized ring includes individual charges 70, or particles (P) of the equally charged fuel stream 52. These nuclei seek their lowest potential energy position continuously, with respect to one another and to their magnetic environment. For the actual fuel ring 85, this is accomplished in a three dimensional environment. The idealized ring is two dimensional, and therefore consideration must be made to control the movements of the nuclei in the third dimension with respect to time or the actual fuel ring will become unorganized and dissipate because of the unbalancing Coulomb repulsion. For the present invention, the solution to this observation is to have a plane of rotation, formed from the rotating ring, move at an angle of ninety degrees (90°) to the ring rotation. In this way, a ring chamber 88, as shown in FIG. 1, is formed with control in all three-dimensional variables.

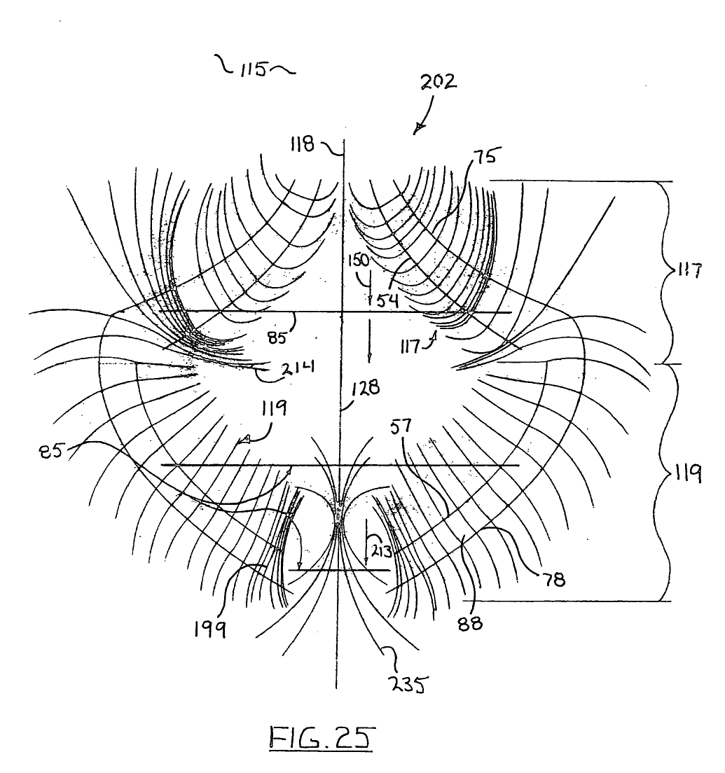

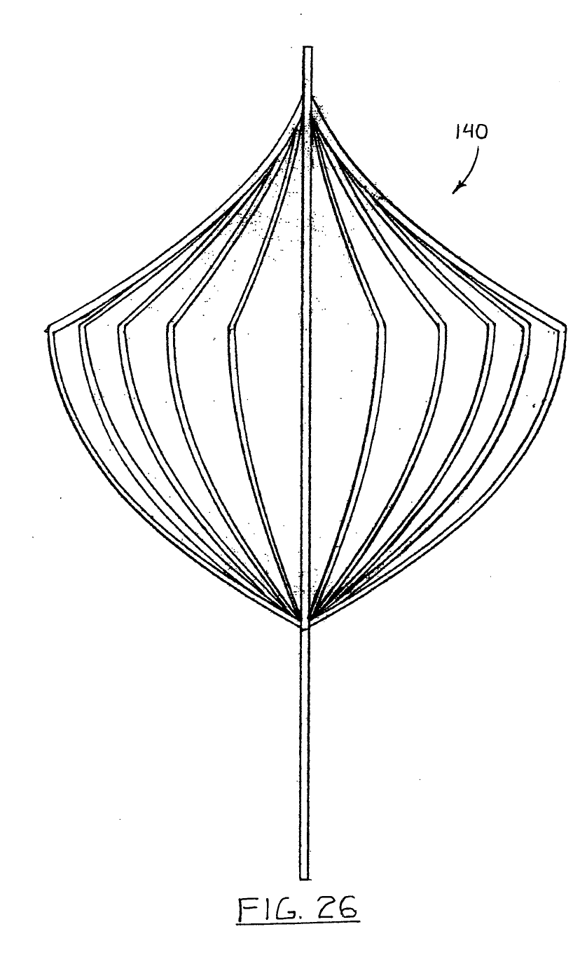

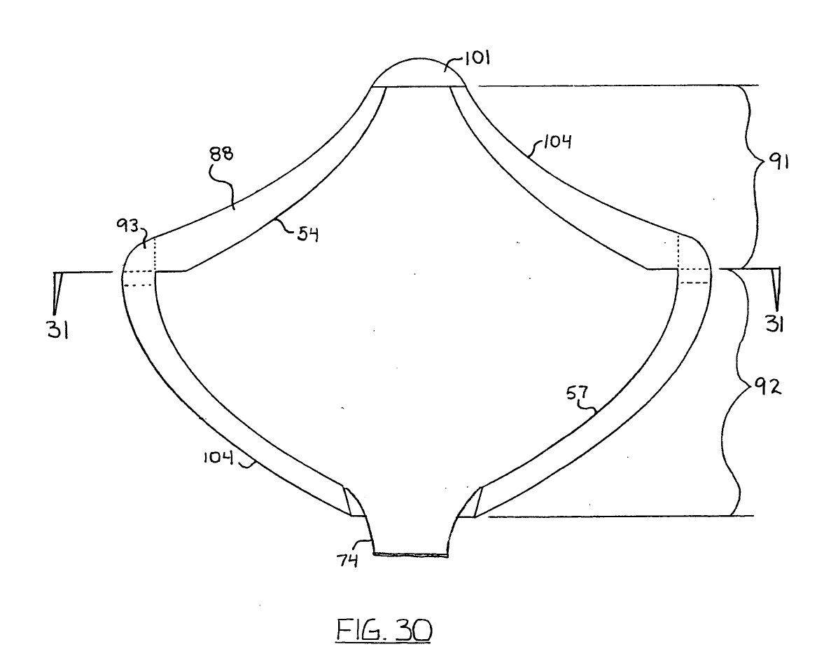

Furthermore, by carefully choosing the geometry of the rate of change of the radius of the fuel ring 85, relative to its position in the ring chamber 88, at the perimeter of the plane of the fuel ring, as shown in FIGS. 25 and 30, the relative linear velocity between charges 70, which in a preferred embodiment of the present invention are nuclei can be increased above that of the angular velocity of the fuel ring. This relative linear velocity can be of sufficient value to be an “Einsteinian” value so that the relative mass of the nuclei increase, giving the mass to charge ratio an advantage for reaction. This opportune geometry of radius reduction serves to greatly increase the relative nuclei to nuclei energy of the fuel stream 52.

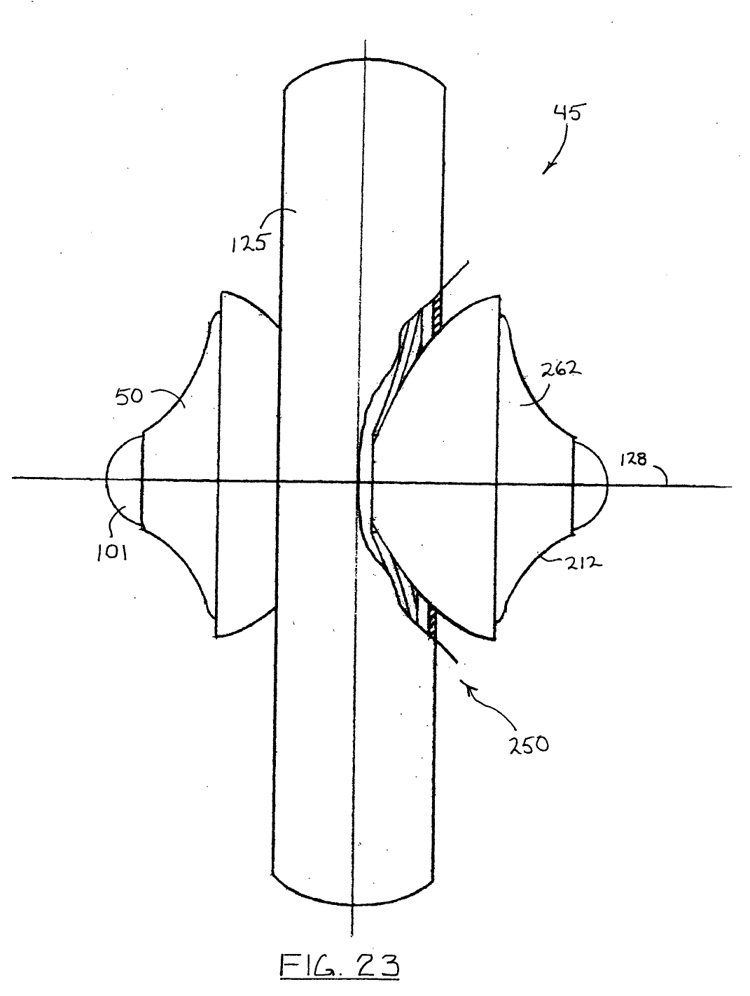

The form of the actual fuel ring 85 is not of classical, deterministic geometry, but of a spiraling, spinning toroid with a volume as small as can be achieved. The smaller the volume of the fuel ring, the greater its stability within the pre-reactor 50. As the thin rotating toroid of the fuel ring moves downward in the compressor 92, and so into a reaction chamber 122, as shown in FIG. 21, the fuel ring must reduce its radius to bring the nuclei closer and closer together, with a relative linear velocity for the reaction to be complete. In the idealized, or classical sense as defined by known rules of particle physics, each nucleus 70, or particle of equal charge, independently seeks a lowest potential energy position, following a three-dimensional, decreasing radius spiral. When the change of position with time lays out the correct geometry then these individual trajectories driven by potential energy positions will collectively form the fuel ring that is dynamic and under control.

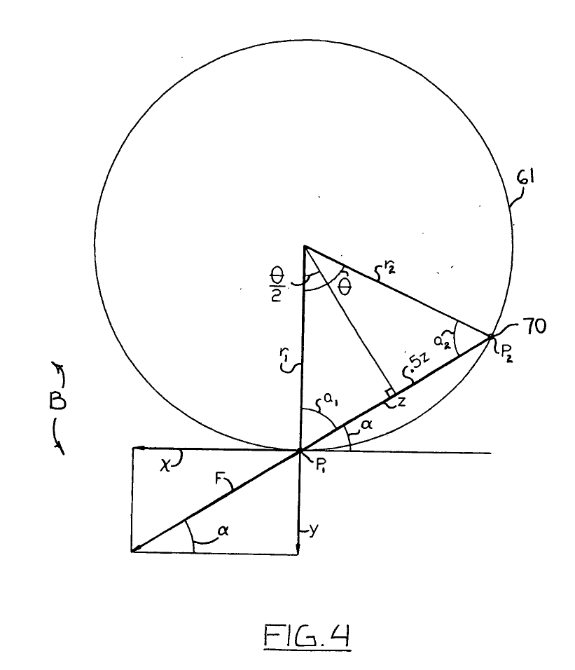

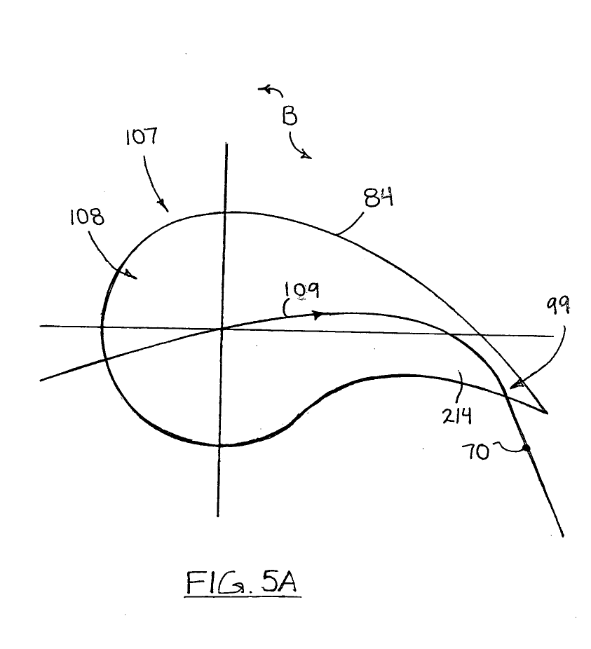

Conceptually, a “magnetic field” (B), is a continuous distribution of energy in a defined space. The energy embodied by the particle (P) within the magnetic field, as shown in FIG. 4, has a kinetic component, which depends on a “time variation of the field strength” or flux, and a potential component, which depends only on an instantaneous value of the field strength. When the field changes, work is performed by the field, which is defined as “induction.” In induction, the balance of kinetic and potential energy shifts. Each point in the defined space can be assigned a numerical value known as a “field strength.” For “work,” the change of a field is relative, as experienced by the charged particle encountering the magnetic field, with respect to its change in position within the magnetic field.

When the particle, or point charge (P), with a given magnitude, direction, and velocity is introduced into a uniform magnetic field (B), its trajectory will be of a constant radius (r), as shown in FIG. 4, and its velocity will not change. No work will be done on this charge, as defined.

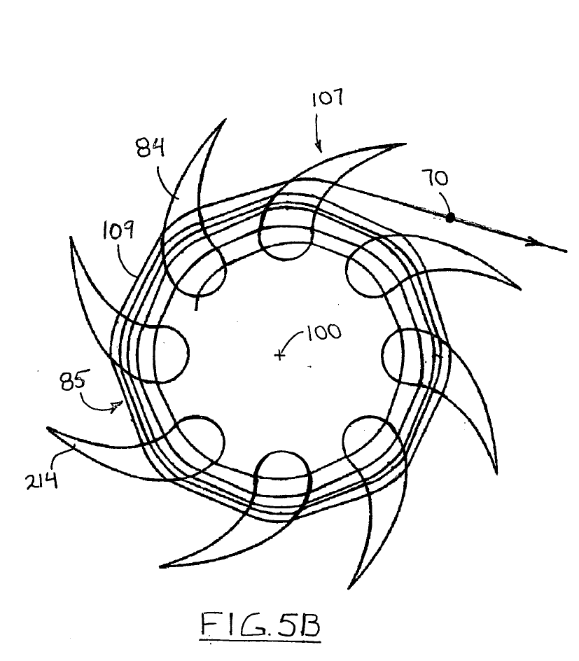

For the present invention, the magnetic field (B) employed within the pre-reactor 50 is non-uniform. FIG. 5A shows a schematic approximation of a magnetic field coil 84, which is stretched on one side and warped in the same plane. The magnetic field generated with this coil is non-uniform and roughly “tear-drop” shape. There is a concentration or an increase of density of the magnetic field at the narrow part 99 of the coil. A technician skilled in the art of magnetic field coil manufacture would be able to fabricate such a coil without undue experimentation. FIG. 5A shows, in plan view, an overlapping pair of non-uniform coils 107, which are also detailed in FIGS. 28A and 28B, as discussed later herein. The pair is energized with an electric current and the resultant magnetic field (B) between these stretched, warped coils is also non-uniform. If an idealized charge 70 then enters this field at its low-density area 108 with a certain velocity, the charge has a trajectory 109 that is decreasing in its radius. Therefore, according to the “Law of Conservation of Angular Momentum,” work is done and the charge will exit the field at a greater linear velocity then it entered. The angular velocity, while in the non-uniform field, increases relative to the decreasing radius. The trajectory of the charge becomes a spiral with a partially declining radius of particles, as shown for the accelerator 91, in FIG. 1.

By arranging, in series and in a circle, additional pairs of these non-uniform coils 107, as shown in FIG. 5B, the overall trajectory 109 of the charged particle 70 becomes segmented. As the charge moves from pair to pair around and around, it is accelerated at each angled, segmented end. The acceleration is additive. Preferably, the electrical current supplied to the coil pairs is adjusted so that the overall spiral is outward and at the optimal velocity. For the present invention, with the ⁶Li ions of fuel comprising the charged particles, the particles accelerate and quickly reach energy levels that release all three electrons from the ⁶Li ions. The energy level to release the last electron of the ⁶Li ion is 203.481 eV, which translates to 9.1554(10⁴) M/s.

The “configuration principle” of charge acceleration can have multiple variables of design and control. For example, in the fuel ring 85 of the pre-reactor 50, the geometry, size, number, and placement of sub-rings, or coils 84, which are preferably in overlapped pairs 107, as discussed above, is a matter of choice. The current in each coil of the pair does not need to be the same, and in this way there is control in the third dimension of the charge trajectory 109.

The trajectory 109 of each charge 70 and thus the final angular velocity of the charge in the accelerator 91 is generally controlled by the placement, angle, and amperage of the magnetic field coils 84. As discussed above, the pre-reactor 50 of the present invention, includes the accelerator 91 and the compressor 92, as shown in FIG. 1. A primary purpose of the accelerator is to increase the angular velocity of the fuel stream 52 received into the pre-reactor. It is not sufficient to only fine-tune the angular velocity of the individual charges of the fuel stream as they exit the accelerator, by effective control of the charges. However, it is also necessary to remove the electrons from the ion, by the use of a change of amperage on any one of the accelerator's coil pairs 107.

As also discussed above, another purpose of the accelerator 91 portion of the pre-reactor 50 is to remove the electrons from the ⁶Li nuclei contained within the fuel stream 52, as a result of the various velocities of the ions encountered. The electrons have a negative charge and therefore their vector force is in the opposite direction in relation to the positive charge vector forces. The lithium ions of the fuel stream enter the accelerator with a positive charge (+1) and therefore carry two electrons per ion with them. These electrons remain until their kinetic energy is of the value for their opposite direction vector forces to pull the electrons away. The remaining positive charges continue moving out and down while still rotating in the same direction with their own small Larmor radius.

The mass of an electron is 9.1(10⁻³¹) kg, and when compared to the mass of the ⁶Li nuclei, 9.9(10⁻²⁷) kg, the electron is approximately four orders of magnitude lighter. Following the standard equation B=mv/rq, where q=charge of the electron [1.6(10⁻¹⁹)C], r=radius of the electron in meters, v=angular velocity of the electron in meters/sec, m=mass of an electron [9.1 (10⁻³¹) kg], and B=the magnitude of the magnetic field in Tesla, the Larmor radius of the electrons enveloped in the magnetic field (B), designed for the ⁶Li charges, is exceedingly small. Their radius is so small that the direction of overall movement of the electrons is determined by the direction of their guiding center drifts, which are then parallel to magnetic field flux lines 115, or “flux lines,” which are shown in FIGS. 24 and 25.

If the flux lines 115 of the magnetic field (B) were exactly parallel to one another, the electrons would drift in either direction along the field. However, if the flux lines are not parallel with respect to direction and intensity, their drift will with time seek out that position in the field of greatest parallel geometry regardless of the field intensity. This is a significant lesson learned by the “mirror” fusion work. In the accelerator 91, of the present invention, this guiding center electron drift, toward field parallel geometry is needed, and defines the direction for the electrons to be removed from the accelerator.

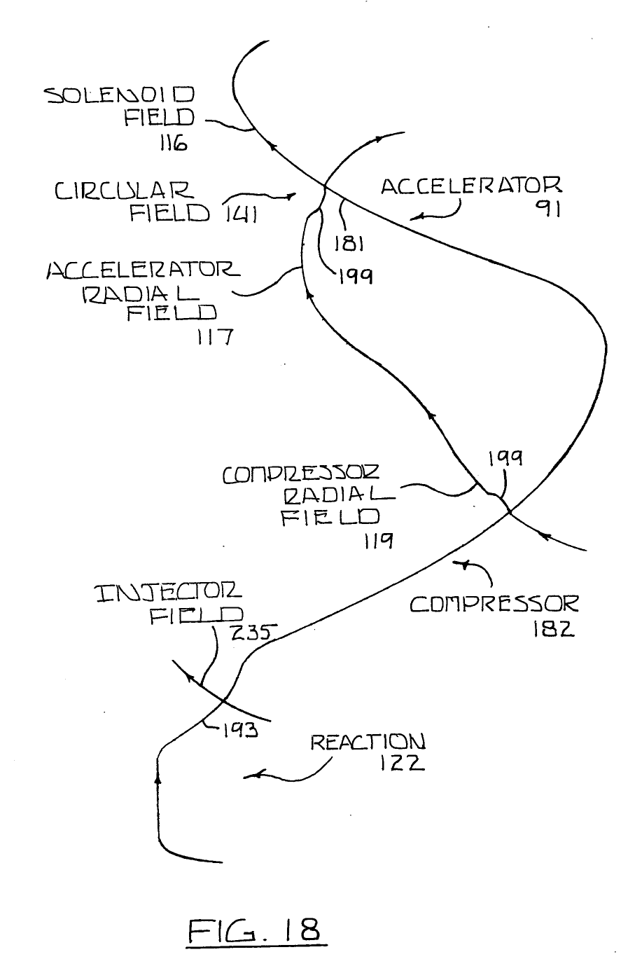

As shown in FIG. 1, in the accelerator center 100, the flux lines 115 of the magnetic field (B), most closely approach a parallel relationship, with respect to each other. The accelerator radial field flux is upward at the accelerator center, along with the upward flux of a ring chamber solenoid field 116 and an accelerator radial field 117. When these flux lines are added together, the flux lines are all directed upward, along the center of the entire pre-reactor 118, as shown in FIGS. 18, 24 and 25.

An appropriate question to ask at this point of the present description is “What is the mechanism for moving the electrons up and out of the center of the pre-reactor 118, and at the same time moving the remaining ions out, perpendicular (⊥) to the electrons' exiting path?” To answer this, the Larmor radii of the ions at the important energy levels must be found.

The standard equation, B=mv/rq, is not adequate alone to predict these radii, because of the number of ions circulating and exerting Coulomb repulsion upon each other. Not only are the ions repelling each other, the electrons that still exist in this center of the accelerator 91, and have not left, are attracting the ions to them. This is an opportunity to control the Larmor radius of these particle ions, or nuclei 70, by manipulating the overall charge of the entire Coulomb force neutralized reactor system 45.

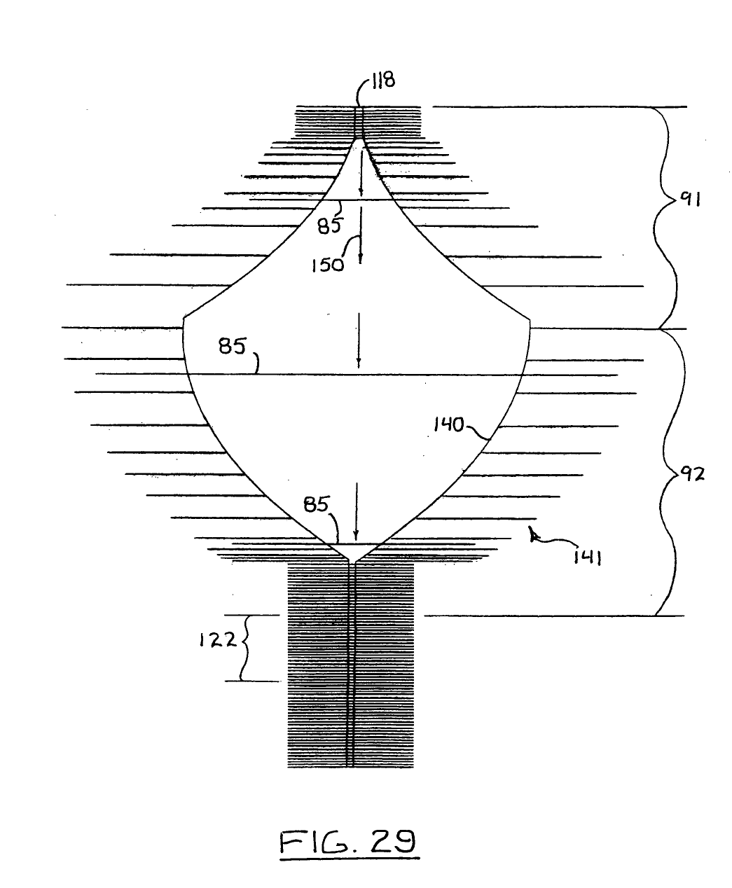

The establishment of the boundaries to define the Larmor radius of these ions is done by finding out the smallest radius and then the largest radius. The smallest radius can be found by making two assumptions. First, by assuming that only one ion exists at a time within a magnetic field with some intensity and/or second that the ions are orbiting within an entirely neutral plasma. The equation for this situation is B=mv/rq, or more appropriately r=mv/Bq. To numerically solve this equation, radius (r) and then the strength of the magnetic field (B) must be found. The “B_{T}” value is the total magnetic field enveloping the ring chamber 88, which includes the general solenoid field 116, as shown in FIGS. 18 and 24, the accelerator field 117 and the compressor radial field 119, as shown in FIGS. 9, 18 and 25, and the circular field 141, as shown in FIG. 29.

As shown through the herein developed equation, B_{T}=[(kqn)/(2πvr²)](0−1n tan π/2n)+(mv)/(rq)Tesla, and using the law of conservation of angular momentum, mvrᵢₙᵢₜᵢₐₗ=mvr_{final}, a Larmor radius boundary limit example can be shown. If v_{f}=3.3(10⁶) M/s, vᵢ=1.098(10⁶) m/s, and r=0.3 m at the top of the compressor 92, then B_{T}=0.35559 Tesla. With the background (B_{T}) value found, the value of the smallest Larmor radius can also be derived. Using r=(mv)/(Bq), where m=9.9(10⁻²⁷) kg, v=1.48 (10⁴) m/s, and q=1.6(10⁻¹⁹)C, then r=0.00258 m. This number not only represents the smallest Larmor radius boundary limit but also is the plasma level with respect to first ionization energy and ionization charge.

The largest Larmor radius (r) values are found by assuming that all the free electrons have been removed from the fuel unit at the first, second, and third ionization energy values and that this condition happens with the same background magnetic field (B_{T}) value of 0.35559 T. Again the basic derived equation for (B_{T}) can be used to solve for (r) at the three ionization levels and at the top of the compressor 92. It must be remembered that this is not an unrealistic assumption, but a definite objective to remove all three electrons from the fuel stream 52, as well as to accelerate the ions of pure ⁶Li nuclei to the required reaction energy.

By taking the basic derived total magnetic field (B_{T}) equation and solving for radius (r), the equation takes on the quadratic form and can be solved using the standard quadratic solution.
r[B_{T} r−(mv)/q]−{[kqn(0−1n tan π/2n)]/[2πv]}=0

Using the above equation, the Larmor radius (r) for the first ionization value with no free electrons is 1.613 m. The second ionization value is r=1.156 m and for the third ionization value, r=1.12534 m. The Larmor radius for the final velocity where the ⁶Li nuclei are accelerated to 1.98(10⁶) m/s is 0.3 m.

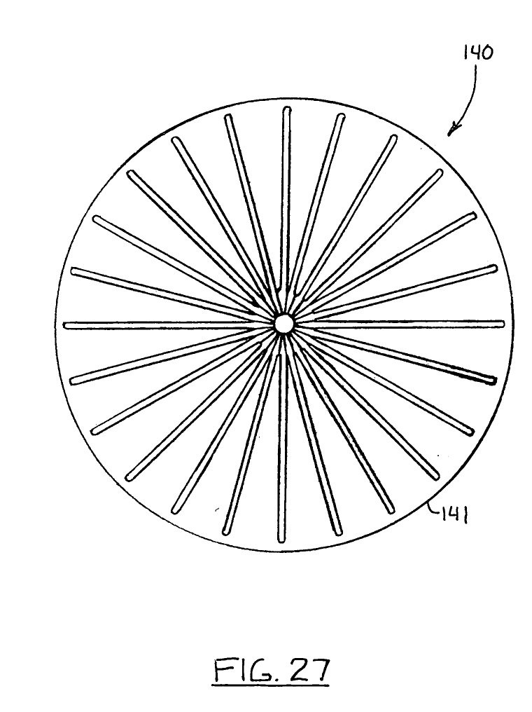

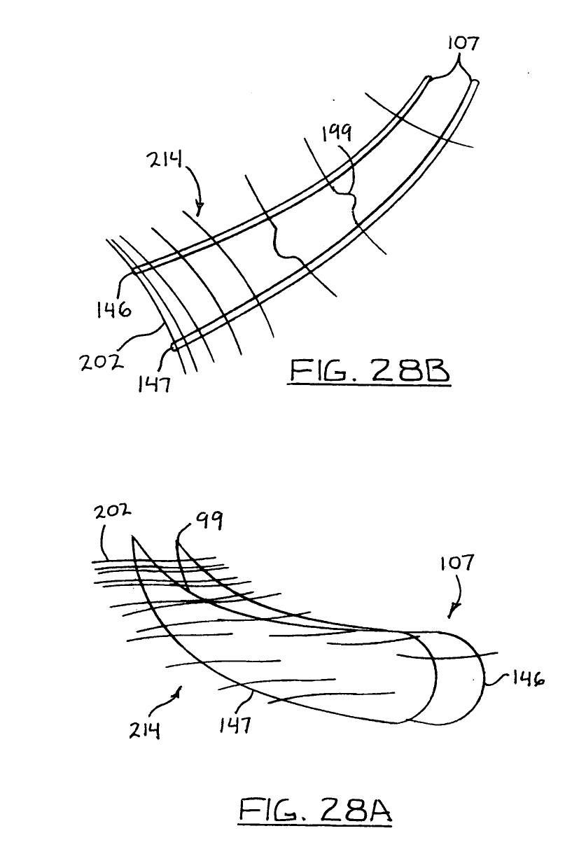

From this above exercise, it is evident that the Larmor radii, at the three ionization levels of ⁶Li, is larger than the final velocity radius of the compressor 92, and this is what is needed for the accelerator 91 to perform its purpose. Emphasizing again, the Larmor radius values found reflect a general solenoid field 116, as shown in FIGS. 18 and 24, and the circular magnetic field 141, as shown in FIGS. 27 and 29. To this field is added the accelerator radial fields 117, which in effect reduce the general radius, which according to accepted conservation foundations increase the velocity and energy level of the ions.

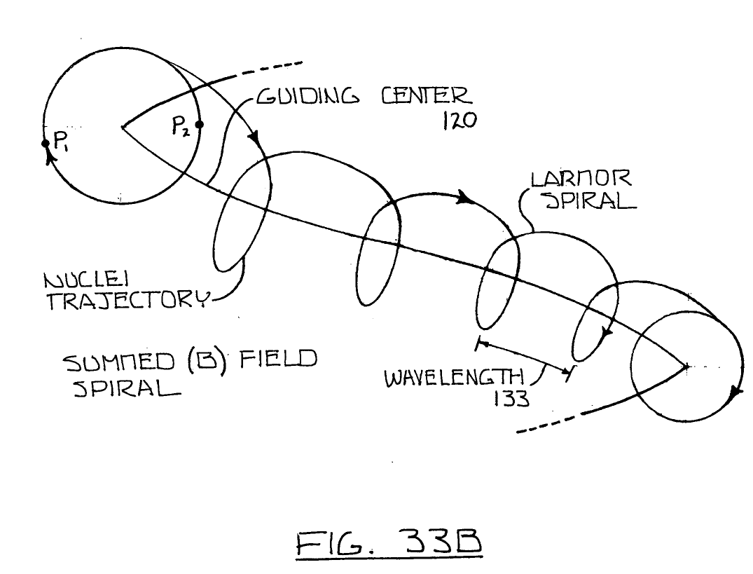

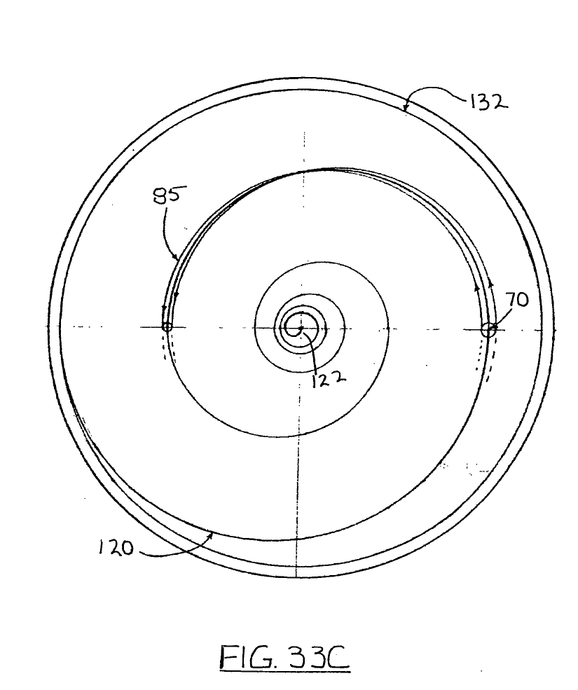

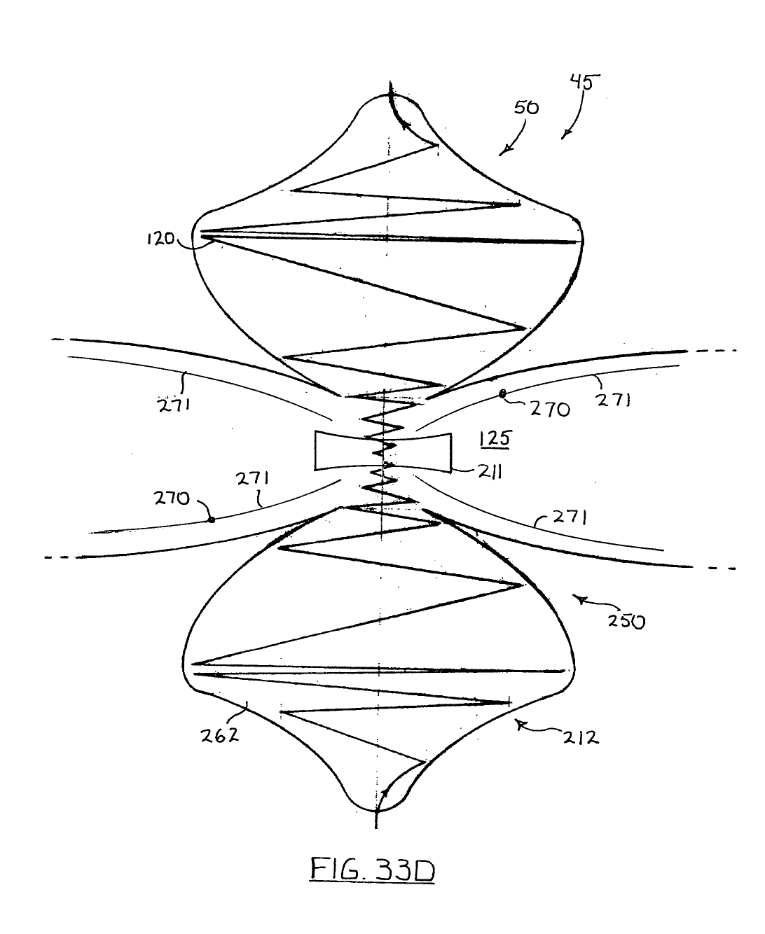

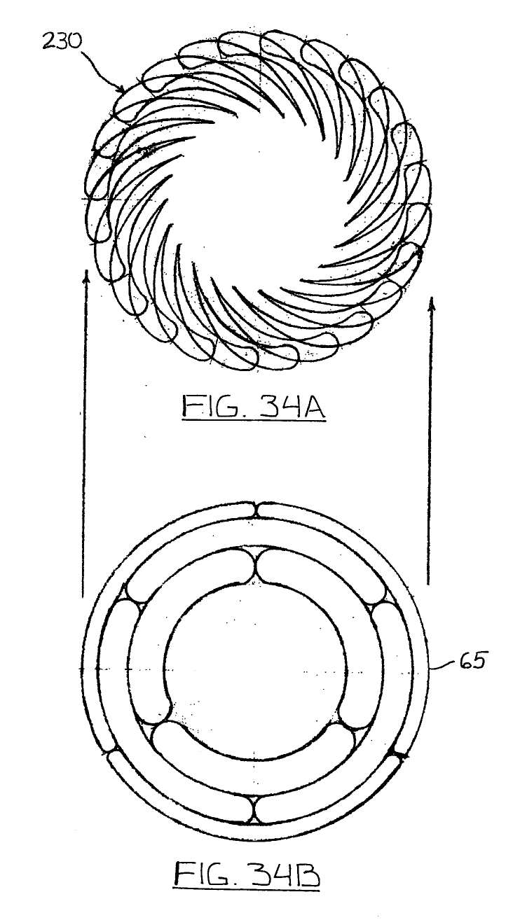

Each of the charges, or nuclei 70 of the fuel stream 52 within the accelerator 91, must move in all three dimensions for control. The accelerating charges, after leaving the thermal chamber or vacuum cap 101, as shown in FIG. 1, move into a circular geometry of the fuel ring 85, which is initially two-dimensional. As the charges accelerate they are directed downward, in addition to their two-dimensional orbit. Control of a guiding center drift 120 of the charges in the stream is accomplished, as shown in FIGS. 33A, B, C and D, and so the trajectory of the charges is controlled. As the second electron comes off the nuclei the positive charge of the nuclei goes from one to two. This immediately changes forces on the charges and the Larmor radius then decreases because of the interaction with the magnetic fields. If at the same time there is a downward magnetic vector then as the radius decreases and the charges move downward they will not collide with their slower counterparts. The nuclei can then continue to accelerate until the third electron moves off. The positive charges then move downward and outward, not colliding with the two (2) positively charged nuclei and then continuing on to accelerate to the required values. Not only does this control the trajectories of the nuclei and remove the electrons, it also keeps the nuclei into an ever increasing angular velocity and energy, thus preventing the nuclei from reacquiring these electrons.

The above point of not allowing the removed electrons from the ionized nuclei 70, to be reacquired, deserves emphasis. The acceleration of the charges with three dimensional control of the trajectories can be accomplished, since the number of charges that have their electrons removed and accelerated is small. Therefore, the Coulomb repulsive force is manageable. Secondly, the geometry of the trajectory of positively charged nuclei causes the majority of the Coulomb forces to cancel, which is the case within the pre-reactor 50, including the accelerator 91 of the present invention. The overall radius of the charges can remain the same at varying velocities, subject to calculations and placement of the paired coil segments 107, and their windings, along with the amperage level to generate the magnetic field (B). By acknowledged laws of particle physics, well known to those skilled in the field, this is always the case.

IIa. Coulomb Forces Across the Ring

The following nomenclature for the derivation of a “ring equation” is employed herein for describing the present invention. Again, the fundamental derivation of these constants and values are well known to persons skilled in the field of physics of nuclear reactions.
π=3.1416
k=Coulomb's constant−8.989(10⁹) Nm²/C²
q=charge of the ⁶Li nuclei−4.8(10⁻¹⁹)C
kq²=2.071(10⁻²⁷)Nm²
r=radius of the ring in meters
z=distance between nuclei in meters
n=number of particles in the ring
v=angular velocity of the ring in meters/second
yₜ=total force on the ring in Newtons (N)
m=mass of ⁶Li nuclei−9.9(10⁻²⁷) kg
B_{R}=Magnetic field value to hold the ring due to Coulomb repulsion in Tesla
B_{C}=Magnetic field value to hold the ring due to centripetal force in Tesla
B_{T}=Total magnetic field in Tesla
U_{T}=Total Potential Energy of the ring
Q=Energy yield for (1) pair of ⁶Li nuclei (20.5 MeV).

For the two dimensional idealized ring 61, a vector equation must be formulated to adequately describe the ring. As shown in FIG. 4 the number (n) of charged particles 70 or nuclei (P) in the ring is dependent upon the radius (r) of the ring and the distance between the particles. This distance is a manifestation of density. In Coulomb's law, the distance between particles is (z). In terms of density:

$$z = \frac{1}{\sqrt[3]{d}} \\ \text{where:} d = density \qquad ( 1 )$$

To solve for the value of (d), (z) has the value of 5.29(10⁻¹³)m, which is found from “muon joining experiments.” Additionally, we can apply the well established “Bohr Radius Equation,” Eq. (2), below, and equate the Bohr radius (rₒ) to (z):

$${r}_{o} = \frac{ℏ}{{m}_{o} {ke}^{2}} \\ \text{where:} ℏ = \frac{h}{2 π} \\ h = \text{Planck’s constant} \\ {m}_{o} = \text{mass of a muon} \\ e = \text{charge of the muon} \\ k = \text{Coulomb’s constant} \qquad ( 2 )$$

Evaluating for (d) with the density of 6.755(10³⁶)particles/m³ produces a set value of (d) for the purposes of the foregoing description of the present invention. The diameter (D) of the ring is then calculated by taking the total number of particles (n), multiplying them by the distance between them (z), and dividing by pi (π):

$$D = \frac{nz}{π} \qquad ( 3 )$$

D=2r where (r) is the radius of the ring. Substituting, 2r=n[5.29(10⁻³)]/π. Solving for (n):
n=1.188 (10¹³)r (4)

The total amount of outward Coulomb repulsive force (y) on the ring 61 that is to be counterbalanced by a magnetic field (B), is the same as that force on an individual particle from all the other positively charged nuclei 70 that form the ring. As applied to FIG. 4, the following equations are useful in applying Coulomb's law to the present invention:

$$\begin{matrix}α = \frac{π}{2} - a & ( 5 ) \\ a = \frac{π - θ}{2} & ( 6 ) \\ α = \frac{π}{2} - ( \frac{π - θ}{2} ) & ( 7 ) \\ α = \frac{θ}{2} & ( 8 ) \\ θ = 2 α & ( 9 ) \\ sin \frac{θ}{2} = \frac{.5 z}{r} & ( 10 ) \\ z = 2 r sin \frac{θ}{2} & ( 11 )\end{matrix}$$

Coulomb's Law is:

$$F = k \frac{{q}_{1} {q}_{2}}{{z}_{12}^{2}} Newtons \qquad ( 12 )$$

Where (q₁) and (q₂) are the same charge, and (z) is defined in Eq. (11), substituting in Eq. (12) gives:

$$F = k \frac{{q}^{2}}{{( 2 r sin \frac{θ}{2} )}^{2}} Newtons \qquad ( 13 )$$

From Eq. (9) θ=2α, therefore:

$$F = k \frac{{q}^{2}}{{( 2 r sin \frac{2 α}{2} )}^{2}} Newtons \qquad ( 14 )$$

By definition:
y=F sin α (15)

Then, substituting Eq. (14) into Eq. (15) and simplifying:

$$\hat{y} = k ( \frac{{q}^{2}}{4 {r}^{2} sin α} ) Newtons \qquad ( 16 )$$

This (ŷ) value of force is just for one pair of nuclei 70. The following steps are then taken to find the total (ŷₜ) value for the entire idealized ring 61. This total value is the sum of all force (ŷ) components of all the pairs of nuclei in the ring. To find this value, the integral of the previous equation is taken and then using the mean value theorem, and multiplying by the number of particles (n), the total force on the ring is found. The limits of the integral are the extremities of the angle between particle pairs (α). Only one-half (½) of the ring and therefore 1/2 of the force is represented with the final equation multiplied by two (2).

The smallest angle is established in the form of a radius (r). To find this value and referring to Eq. (8):

$$Minimum α = \frac{π}{n} \qquad ( 17 )$$

The maximum angle (α) is (½π), and is the upper limit.

Therefore, the integral with limits then is:

$$\frac{{\hat{y}}_{t}}{2} = \frac{{kq}^{2}}{4 {r}^{2}} {\int }_{\frac{π}{n}}^{\frac{π}{2}} \frac{1}{sin α} ⅆ α \qquad ( 18 )$$

The integral is evaluated in a straightforward manner giving:

$$\frac{{\hat{y}}_{t}}{2} = \frac{{kq}^{2}}{4 {r}^{2}} ( ln tan \frac{α}{2} {\vert}_{\frac{π}{n}}^{\frac{π}{2}} ) \qquad ( 19 )$$

Evaluating the limits gives the following relationship:

$$\frac{{\hat{y}}_{t}}{2} = \frac{{kq}^{2}}{4 {r}^{2}} ( 0 - ln tan \frac{π}{2 n} ) \qquad ( 20 )$$

Eq. (20) represents the area under the curve of the function of (ŷ) but without any specific coordinates. Furthermore the curve of the (ŷ) function is continuous and smooth and not representative of the segmented ring expressed by the particles that form it. To find the total force (ŷₜ) on any single particle (P₁), all the (ŷ) vectors from each nuclei in its position around the ring relative to any particle 70, must be added. By dividing Eq. (20) by the maximum limit of (α) which is (½π), the area expressed by the integral is defined in terms of a rectangle where (½π) becomes the value of the (x) coordinate. The result of the division is the value of the mean (ŷ) coordinate. This exercise is in accordance with the mean value theorem where the (ŷ) value is the mean of all the (ŷ) vectors of the nuclei in the ring. Dividing Eq. (20) by (1/2π) gives:

$$\text{mean} \frac{{\hat{y}}_{t}}{2} = \frac{{kq}^{2}}{2 π {r}^{2}} ( 0 - ln tan \frac{π}{2 n} ) \text{Newtons} \qquad ( 21 )$$

Because only 1/2 of the ring is represented by Eq. (21) this (ŷ) component is then multiplied by (½n) to find ½ of the total force (ŷₜ). In effect this is adding the (ŷ) vectors from each nucleus.

$$\frac{{\hat{y}}_{t}}{2} = \frac{{kq}^{2} n}{4 π {r}^{2}} ( 0 - ln tan \frac{π}{2 n} ) \text{Newtons} \qquad ( 22 )$$

This equation is then multiplied by 2 for both sides of the ring to get (ŷₜ)

$${\hat{y}}_{t} = \frac{{kq}^{2} n}{2 π {r}^{2}} ( 0 - ln tan \frac{π}{2 n} ) \text{Newtons} \qquad ( 23 )$$

Substituting Eq. (4):

$${\hat{y}}_{t} = \frac{1.188 ( {10}^{13} ) {kq}^{2}}{2 π r} [ 0 - ln tan \frac{π}{2.376 ( {10}^{13} ) r} ] \text{Newtons} \qquad ( 24 )$$

Using the values in the nomenclature for (π), (k), and (q) and evaluating gives:

$${\hat{y}}_{t} = \frac{3.916 ( {10}^{- 15} )}{r} [ 0 - ln tan \frac{1.322 ( {10}^{- 13} )}{r} ] \text{Newtons} \qquad ( 25 )$$

In FIG. 4, it is apparent that the (x) component of the force vector (F) cancels when added to its mirror image partner on the other side of the ring 61; whereas, the (y) component of this partner is a positive addition. For example if (r) is (0.18 m) then (θ) in terms of this (r) at its smallest angle is 2.939(10⁻¹²) radians. Using Coulomb's force equation, where z=5.29(10⁻¹³)m, then F=7.4(10⁻³)N. By definition, y=F sin θ/2, then (y) equals 1.087 (10⁻¹⁴)N. Using the Pythagorean theorem, (x) equals 7.4(10⁻³)N, which equates to (F). In other words, to a very large extent the Coulomb repulsion between the particles 70 in the ring are canceled. This is significant. The overwhelming Coulomb repulsion between the particles at the given distance of 5.29(10⁻¹³)m is expressed by the (x) component of the (F) vector. This is a fundamental fact that makes the rotating fuel ring 85 of the present invention a very attractive alternative to the conventional, thermonuclear approach to fusion.

The magnetic field (B) that holds the spinning, idealized ring 61 must be equal to the sum of the forces on the nuclei or particles 70 that form the ring, which is the total magnetic field vector (F_{T}) sum, conventionally measured in Teslas. The following equation addresses the amount of force exerted on any of the particles (P), at a given velocity, and moving through a magnetic field of a given value. The equation is:
F=qvB_{R} sin θ (26)

To simplify this analysis the assumption is made that the nuclei path crosses the magnetic field at (½π), making the sin (θ) equal to one (1).
Then:

$${B}_{R} = \frac{F}{qv} \qquad ( 27 )$$

Using this equation it can be shown that the magnetic field value to contain the entire ring is the same as that field strength to hold one particle in place. This can be done simply by using Coulomb's Law with Eq. (27) and simplifying giving:

$${B}_{R} = \frac{kq}{ν {r}^{2}} \qquad ( 28 )$$

The magnetic field force (B), directed at each particle individually is the same value for the ring as a whole.

To find the strength of the magnetic field to hold the ring in place horizontally due to the Coulomb repulsion, Eq. (23) is combined with Eq. (27) giving:

$${B}_{R} = \frac{kqn}{2 πν {r}^{2}} ( 0 - ln tan \frac{π}{2 n} ) \text{Tesla} \qquad ( 29 )$$

Because the plane of rotation of the ring 61 is perpendicular (⊥) to its central axis, there is a centripetal force. Without this rotation there would be no magnetic interaction. This centripetal force and the centripetal magnetic field (B_{c}) to contain this force is expressed by the following equation:

$${B}_{c} = \frac{mν}{rq} \text{Tesla} \qquad ( 30 )$$

The total magnetic field (B_{T}) to maintain the ring at the density of 6.755(10³⁶) particles/m³ is the sum of both the Coulomb repulsion force magnetic field (B_{R}), and the centripetal magnetic field (B_{C}).
B_{T}=B_{R}+B_{c} (31)

Now Eq. (29) and Eq. (30) are put into Eq. (31) that results in the following equation:

$${B}_{T} = \frac{kqn}{2 πν {r}^{2}} ( 0 - ln tan \frac{π}{2 n} ) + \frac{mν}{rq} \text{Tesla} \qquad ( 32 )$$

Evaluating using Eq. (4) and the nomenclature list:

$${B}_{T} = \frac{8.159 ( {10}^{3} )}{ν r} [ 0 - ln tan \frac{1.322 ( {10}^{- 13} )}{r} ] + \frac{2.062 ( {10}^{- 8} ) ν}{r} \text{Tesla} \qquad ( 33 )$$

Using Eq. (29), (30), and (31), the following tables and accompanying graphs are made by first varying the angular velocity (v) of particles 70 in the ring 61, and then the radius (r) of the idealized ring, as referenced in FIG. 4.

TABLE 1.1
Bt Varying Angular v

| angular v | r | Br | Bc | Bt |
|---|---|---|---|---|
| 9.00E+05 | 0.1 | 2.479599 | 0.185625 | 2.665224 |
| 1.20E+06 | 0.1 | 1.8597 | 0.2475 | 2.1072 |
| 1.50E+06 | 0.1 | 1.48776 | 0.309375 | 1.797135 |
| 1.80E+06 | 0.1 | 1.2398 | 0.37125 | 1.61105 |
| 2.10E+06 | 0.1 | 1.062685 | 0.433125 | 1.49581 |
| 2.40E+06 | 0.1 | 0.92985 | 0.495 | 1.42485 |
| 2.70E+06 | 0.1 | 0.826533 | 0.556875 | 1.383408 |
| 3.00E+06 | 0.1 | 0.74388 | 0.61875 | 1.36263 |
| 3.30E+06 | 0.1 | 0.676254 | 0.680625 | 1.356879 |
| 3.60E+06 | 0.1 | 0.6199 | 0.7425 | 1.3624 |
| 3.90E+06 | 0.1 | 0.572215 | 0.804375 | 1.37659 |
| 4.20E+06 | 0.1 | 0.531343 | 0.86625 | 1.397593 |
| 4.50E+06 | 0.1 | 0.49592 | 0.928125 | 1.424045 |

[image] TABLE 1.2
Bt Varying r

| angular v | r | Br | Bc | Bt |
|---|---|---|---|---|
| 3.30E+06 | 0.1 | 0.676254 | 0.680625 | 1.356879 |
| 3.30E+06 | 0.11 | 0.616919 | 0.61875 | 1.235669 |
| 3.30E+06 | 0.12 | 0.567302 | 0.567188 | 1.13449 |
| 3.30E+06 | 0.13 | 0.525186 | 0.523558 | 1.048744 |
| 3.30E+06 | 0.14 | 0.488981 | 0.486161 | 0.975142 |
| 3.30E+06 | 0.15 | 0.457519 | 0.45375 | 0.911269 |
| 3.30E+06 | 0.16 | 0.429922 | 0.425391 | 0.855313 |
| 3.30E+06 | 0.17 | 0.405514 | 0.400368 | 0.805882 |
| 3.30E+06 | 0.18 | 0.383771 | 0.378125 | 0.761896 |
| 3.30E+06 | 0.19 | 0.364276 | 0.358224 | 0.7225 |
| 3.30E+06 | 0.2 | 0.346696 | 0.340313 | 0.687009 |
| 3.30E+06 | 0.21 | 0.330761 | 0.324107 | 0.654868 |
| 3.30E+06 | 0.22 | 0.316249 | 0.309375 | 0.625624 |

[image]

IIb. Potential Energy of the Ring

The classical expression between a pair of point charges (q₁) and (q₂), for potential energy is Coulomb's equation:

$$U = k \frac{{q}_{1} {q}_{2}}{{z}_{12}} \text{Joules} \qquad ( 34 )$$

From the force analytical determination, as discussed above and diagramed in FIG. 4, it was shown that (z) is the distance between the particles 70, and that z=2r sin 1/2θ, where (r) is the radius of the idealized ring 61. Using this, Coulomb's potential energy equation becomes:

$$U = \frac{{kq}^{2}}{2 r sin \frac{θ}{2}} \text{Joules} \qquad ( 35 )$$

This represents one-half (1/2) of the ring so the equation is then:

$$\frac{U}{2} = \frac{{kq}^{2}}{2 r sin \frac{θ}{2}} \text{Joules} \qquad ( 36 )$$

To prepare the equation for the integral work the above relationship is transformed to:

$$\frac{U}{2} = \frac{{kq}^{2}}{2 r} \cdot \frac{1}{sin \frac{θ}{2}} \text{Joules} \qquad ( 37 )$$

The minimum angle (θ) with point particle (P) and thus the lower limit of the integral is 2π/n. The maximum angle (θ) with (P) and thus the upper limit of the equation is pi (π) radians. The integral is then written thus:

$$\frac{U}{2} = \frac{{kq}^{2}}{2 r} {\int }_{\frac{2 π}{n}}^{π} \frac{1}{sin \frac{θ}{2}} ⅆ \frac{θ}{2} \text{Joules} \qquad ( 38 )$$

This expression is then evaluated giving:

$$\frac{U}{2} = \frac{{kq}^{2}}{2 r} ( 0 - ln tan \frac{π}{2 n} ) \text{Joules} \qquad ( 39 )$$

Again following the same methodology to determine (yₜ), which is the total of the (y) forces on any particle (P₁). Employing the mean value theorem, this relationship is divided by the maximum limit in radians of (1/2π) and multiplied by (½n) since this is still one-half (1/2) of the ring. It is then multiplied by two (2) to give the value for the whole ring. The resulting equation from this is:

$$U = \frac{{kq}^{2} n}{π r} ( 0 - ln tan \frac{π}{2 n} ) \text{Joules} \qquad ( 40 )$$

This represents the potential energy involving only one of the particles 70 in the idealized ring 61, as shown in FIG. 4. To get the total potential energy (U_{T}) of the entire ring this equation must again be multiplied by the total number of particles (n) giving:

$${U}_{T} = \frac{{kq}^{2} {n}^{2}}{π r} ( 0 - ln tan \frac{π}{2 n} ) Joules \qquad ( 41 )$$

Again using the nomenclature values and Eq. (4) and evaluating:

$${U}_{T} = 9.3 ( {10}^{- 2} ) r [ 0 - ln tan \frac{1.322 ( {10}^{- 13} )}{r} ] Joules \qquad ( 42 )$$

Eq. (42) then represents the work needed to compress one ring horizontally to a density of 6.755(10³⁶) particles/m³. From this equation and Eq. (33) the following table and graphs are made:

TABLE 2.1
Potential Energy/Ring Varying r

| angular v | r | Bt | Ut |
|---|---|---|---|
| 3.30E+06 | 0.02 | 6.584611 | 0.047881 |
| 3.30E+06 | 0.04 | 3.33515 | 0.09834 |
| 3.30E+06 | 0.06 | 2.240141 | 0.149773 |
| 3.30E+06 | 0.08 | 1.688997 | 0.201838 |
| 3.30E+06 | 0.1 | 1.356714 | 0.254372 |
| 3.30E+06 | 0.12 | 1.134352 | 0.307282 |
| 3.30E+06 | 0.14 | 0.975024 | 0.360502 |
| 3.30E+06 | 0.16 | 0.855209 | 0.41399 |
| 3.30E+06 | 0.18 | 0.761804 | 0.46771 |
| 3.30E+06 | 0.2 | 0.686926 | 0.521637 |
| 3.30E+06 | 0.22 | 0.625549 | 0.575751 |
| 3.30E+06 | 0.24 | 0.574317 | 0.630034 |
| 3.30E+06 | 0.26 | 0.530899 | 0.684473 |

[image]

Using the herein derived (U_{T}) potential energy values, a table and graph of expected energy output of the Coulomb force neutralized reactor system 45 of the present invention can be made, which is dependent upon the number of particles per second traveling through the system. For this table the radius (r) value of the idealized ring 61 is held constant at 0.18 m, which approximates a preferred radius of the actual fuel ring 85. The energy (Q) value for the ⁶Li-⁶Li fusion reaction is 20.5 MeV. (Q) is stated in terms of Joules (J), where 1 MeV=1.602×10⁻¹³ J. Because the (Q) value is the result of a pair of nuclei reacting, Q=1/2n(1.602×10⁻¹³)(20.5)J where (n) is the number of nuclei or particles 70 in the ring. Again using Eq. (4) and simplifying: Q=19.507r, in joules. This is the energy produced per ring with radius (r). The usable energy of this reactor system is then (Q) minus (U_{T}).

TABLE 3.1
Net Q/Ring

| angular v | r | Bt | Ut | Q | Net Q/Ring |
|---|---|---|---|---|---|
| 3.30E+06 | 0.02 | 6.584611 | 0.047881 | 0.39014 | 0.342259066 |
| 3.30E+06 | 0.04 | 3.33515 | 0.09834 | 0.78028 | 0.681939625 |
| 3.30E+06 | 0.06 | 2.240141 | 0.149773 | 1.17042 | 1.020646942 |
| 3.30E+06 | 0.08 | 1.688997 | 0.201838 | 1.56056 | 1.358722235 |
| 3.30E+06 | 0.1 | 1.356714 | 0.254372 | 1.9507 | 1.696327559 |
| 3.30E+06 | 0.12 | 1.134352 | 0.307282 | 2.34084 | 2.033558362 |
| 3.30E+06 | 0.14 | 0.975024 | 0.360502 | 2.73098 | 2.370477714 |
| 3.30E+06 | 0.16 | 0.855209 | 0.41399 | 3.12112 | 2.70713044 |
| 3.30E+06 | 0.18 | 0.761804 | 0.46771 | 3.51126 | 3.043550057 |
| 3.30E+06 | 0.2 | 0.686926 | 0.521637 | 3.9014 | 3.37976258 |
| 3.30E+06 | 0.22 | 0.625549 | 0.575751 | 4.29154 | 3.715788792 |
| 3.30E+06 | 0.24 | 0.574317 | 0.630034 | 4.68168 | 4.051645679 |
| 3.30E+06 | 0.26 | 0.530899 | 0.684473 | 5.07182 | 4.387347387 |

[image] TABLE 3.2
Net Q in Rings/Second

| Rings/ | | | | |
|---|---|---|---|---|
| Second | r in meters | Ut in joules | Q in joules | Net Q in joules |
| 0 | 0.18 | 0 | 0 | 0 |
| 2500000 | 0.18 | 1169274.856 | 8778150 | 7608875.144 |
| 5000000 | 0.18 | 2338549.713 | 17556300 | 15217750.29 |
| 7500000 | 0.18 | 3507824.569 | 26334450 | 22826625.43 |
| 10000000 | 0.18 | 4677099.425 | 35112600 | 30435500.57 |
| 12500000 | 0.18 | 5846374.282 | 43890750 | 38044375.72 |
| 15000000 | 0.18 | 7015649.138 | 52668900 | 45653250.86 |
| 17500000 | 0.18 | 8184923.994 | 61447050 | 53262126.01 |
| 20000000 | 0.18 | 9354198.851 | 70225200 | 60871001.15 |
| 22500000 | 0.18 | 10523473.71 | 79003350 | 68479876.29 |
| 25000000 | 0.18 | 11692748.56 | 87781500 | 76088751.44 |
| 27500000 | 0.18 | 12862023.42 | 96559650 | 83697626.58 |
| 30000000 | 0.18 | 14031298.28 | 105337800 | 91306501.72 |
| 32500000 | 0.18 | 15200573.13 | 114115950 | 98915376.87 |
| 35000000 | 0.18 | 16369847.99 | 122894100 | 106524252 |
| 37500000 | 0.18 | 17539122.85 | 131672250 | 114133127.2 |
| 40000000 | 0.18 | 18708397.7 | 140450400 | 121742002.3 |
| 42500000 | 0.18 | 19877672.56 | 149228550 | 129350877.4 |
| 45000000 | 0.18 | 21046947.41 | 158006700 | 136959752.6 |
| 47500000 | 0.18 | 22216222.27 | 166784850 | 144568627.7 |
| 50000000 | 0.18 | 23385497.13 | 175563000 | 152177502.9 |

[image]

IIc. Ring Forces

As derived above, the classical two-dimensional equation that describes the idealized ring 61, which accurately describes the fuel ring 85 in the Coulomb force neutralized reactor system 45 of the present invention, is:
B_{T}=kqn/2 πvr²(0−1n tan π/2n)+mv/rq Tesla (43)
Where:
π=3.1416
k=Coulomb's Constant 8.989 (10⁹) Nm²/C²
q=Charge of the ⁶Li nuclei 4.8 (10⁻¹⁹)C
r=radius of the ring in meters
n=number of particles in the ring
v=angular velocity of the ring in meters/second
m=mass of the ⁶Li nuclei=9.9 (10⁻²⁷) kg
B_{T}=Total magnetic field in Tesla

The first half of the sum of the equation describes the Coulomb force of the idealized ring 61 and is the sum of all the forces between the all particles 70 or charges, with every combination available respective to the number (n) of charges. The last half of the sum of the equation is the amount of centripetal force on each charge given its mass and angular velocity. This equation is an idealistic model of the ring at a moment in time. Additionally, this equation is valuable because it describes the idealized ring in the macro framework. It gives definition to the forces that must be controlled down to the micro/nuclear dimensions, where uncertainty becomes dominant.

In the Coulomb force neutralized reactor system 45, each of the charged particles 70 of the fuel stream 52, in seeking its particle position “P,” is responding to all the other positive charges in the actual fuel ring 85, governed by the Coulomb repulsive forces. When one charge moves, all the other charges in the reactor system respond. The position and force of each of these other charges determines the amount of correction of position, which in turn requires a corresponding adjustment of position by all the other charges, and so forth. The result of all this jostling, even when dampened to a great extent by the spiral trajectory within the pre-reactor 50, is that none of the charges are equal in distance from each other at one moment in time.

Conventional knowledge dictates that the “infrastructure,” necessary to construct and guide the actual fuel ring 85 of the present invention, cannot be manufactured perfectly in its dimensions. The fuel ring, spinning through the structure of the pre-reactor 50, would be expected to develop a “three-dimensional frequency.” In other words, each of the nuclei 70, or particles of the fuel stream 52, develop a three-dimensional angular velocity. To compensate, the frequency of the fuel ring is adjusted and controlled, to become a fundamental frequency for the fuel ring at any point of position and time. The geometry of the fuel ring's wave is three-dimensional. The wavelength of the fuel ring wave is not constant because of ring compression. Additionally, the toroidal nature of the fuel ring generates a wavelength 133, which is different with respect to any position on the toroid at the same frequency. This energy discrepancy requires the wave to roil around the inner and outer radii of the toroid, as shown in FIGS. 33A, 33B, and 33C.

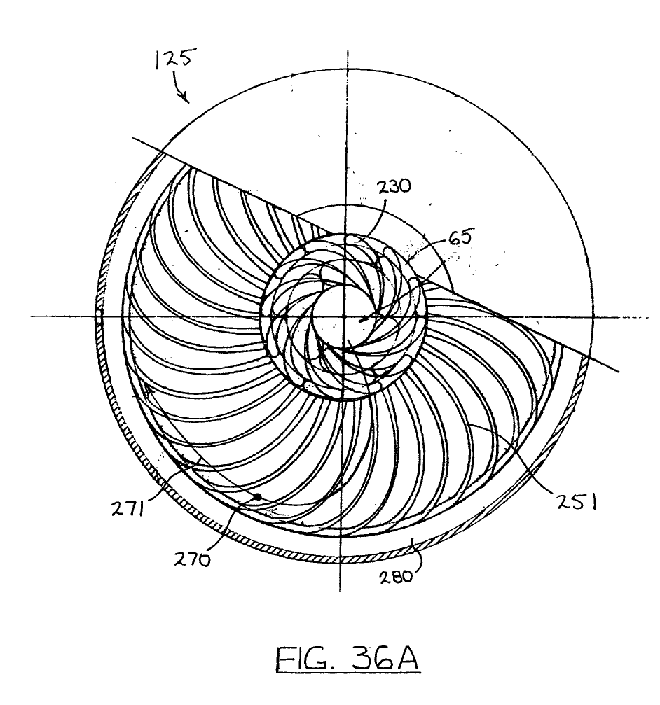

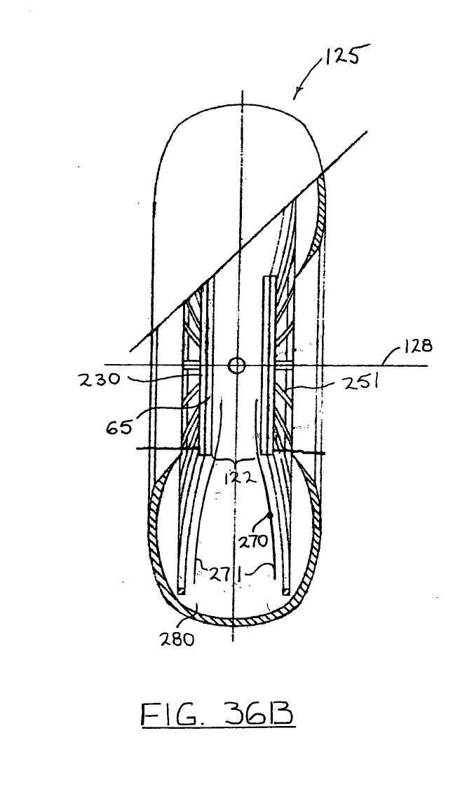

The Coulomb force neutralized reactor system 45 of the present invention addresses the problems inherent in conventional reactor designs by compensating for the ever-present uncertainty of angular velocity and angular position of the charges or particles 70 in the fuel stream 52. There is the danger that at high charge densities, spurious fusion reactions can take place at random places around the fuel ring 85. This destruction of the fuel ring geometry as a result of these reactions causes inefficiencies, so that the goals of the reactor system would not be met. Furthermore, to achieve the proper efficiency of the reaction of the entire fuel ring, the position of the reaction needs to be placed so that the reaction products can expand into a generator 125, as shown in FIG. 36A, and not up into the compressor 92, where radius reduction in the fuel ring takes place.

Controlling the changing wavelength 133 of the particles 70, or “charges,” in the fuel ring 85 is a critical task. Another critical requirement is the alignment of the magnetic moments of the nuclei along with equalizing their two energy states. Achieving these requirements neutralizes the Coulomb repulsive force between the charges, because of the addition of the attractiveness of the aligned nuclear magnetic poles. This expands the cross section or relative probability of reaction and reduces the framework of uncertainty where the reaction can take place.

The concave geometry of the sum of the magnetic fields (B) in both the compressor 92 and the reaction chamber 122, as shown in FIG. 21, not only increases the angular energy of each nuclei in terms of radius reduction of the fuel ring 85, but also increases the relative linear energy of the nuclei 70, one to its neighbor. This energy is in terms of a ring frequency and accordingly, the ring wavelength 133, as shown in FIGS. 33A and 33B. At the density levels in the reaction chamber, the ring wavelength, due to this linear energy, becomes a fraction of the circumference of the ring and therefore at this level the ring moves in steps. In the reaction chamber, it is possible that the relative linear velocity will have relativistic values. This increases the relative linear mass of the nuclei, while at the same time maintaining non-relativistic angular velocities and angular mass all due to the concave geometry of the magnetic fields (B). Therefore, the mass/charge ratio is improved, increasing the probability of reaction. The ring wavelength is derived from the Larmor radius of the charges. This does not mean that the nuclei are equidistant from one another. Because of the constricting toroidal geometry of the ring at this point, the nuclei merge, approaching fusion.

According to accepted premises of nuclear physics, the ⁶Li nucleus has certain characteristics. It has a mass number “A,” an atomic number or proton number “Z,” and a quantum number or nuclear spin “I.” The ⁶Li nucleus then has an even mass number (A), and an odd proton number (Z), which gives a nuclear spin (I) as a whole integer. Therefore, the ⁶Li nucleus possesses a magnetic moment. Since there is a magnetic moment, the polarity of the nucleus can be controlled in the externally applied magnetic field (B).

It is well known that the magnetic moment of the ⁶Li nucleus precesses, and is called the nuclear angular momentum. Its value is described as |I|=square root [I(I+1) [symbol] ]

$$\begin{matrix}where \text{:} \\ I = nuclear spin ( I ) \\ ℏ = \frac{h}{2 π} \\ h = Planck ’ s constant\end{matrix}$$

Aligning these moments gives recognition to the nucleus in the fuel ring 85, as having two energy states; E₁ and E₂. If the magnetic moment is aligned with the external magnetic field (B) field it has an energy state of (E₁). If it is aligned against the magnetic field (B) then it has a higher energy state (E₂). These two states must be equalized, and in the process the poles of the nuclear magnetic field are set up to be north (N) to south (S), to (N) to (S), etc. In established magnetic resonance, both energy states (E) alternate. In the present invention, only one energy state (E) needs to be changed.

The well known mechanism of magnetic resonance sets up a secondary frequency that is superimposed upon the toroidal ring frequency, and therefore the ring wavelength 133, created by the charges 70, or nuclei, seeking their lowest potential energy position. The toroidal ring wavelength is described by a “Larmor radial frequency.” The precession of the nuclear angular momentum is described by a “Larmor precessional frequency.” The secondary external electromagnetic frequency needed in the mechanism of magnetic resonance then is superpositioned upon the Larmor radial frequency creating a “beat frequency.” This creates a tendency for pressure nodes or density nodes to appear around the fuel ring 85. The tendency for node creation is important because node formation is resisted by the Coulomb repulsion around the ring. This tendency increases reaction efficiency.

In standard magnetic resonance, the precessional frequency of the magnetic field (B), which oscillates the nuclei 70, alternates the poles of the nuclei, so that all the aligned magnetic moments move from one pole to the other in alignment. The energy states of all the nuclei change with respect to their precessional frequency. This is not what is needed in the fuel ring 85 of the present invention. In the fuel ring, only one energy state needs to be changed. Then all the nuclei are the same. The resonant frequency is pulsed in one direction at the precessional pulse rate. This is the same principle of a conventional and simple, direct current generator, where all the voltage produced has the same sign but does not have a steady current. The voltage has a waveform with the same sign or direction, and it is also exhibits the same phase.

The Larmor radial ring frequency and associated ring wavelength 133, are a function of the circumference of the fuel ring 85, and therefore the beat frequency wavelength is also a function of the circumference. Therefore the density nodes are equidistant from one another. By controlling the Larmor radial ring frequency the number and position of the density nodes is controlled relative to the Larmor precessional frequency.

For the present invention, the classically defined framework of “uncertainty” is the node where there is nuclear magnetic pole alignment, the lowest potential energy position, the force of magnetic compression with polarity attraction neutralizes Coulomb repulsion and resident time of the nuclei, or charges 70, with the charges relative linear velocity and relative linear momentum converging at the locus of reaction. In an unrestricted environment, increasing the energy of a defined system increases the uncertainty of the systems' components with respect to position and velocity. In the present invention, increasing the energy of the Coulomb force neutralized reactor system 45 is a necessary component of interaction with a restricted environment that reduces the framework of uncertainty. This does not violate the laws of thermodynamics or the conservation laws because in the end energy is conserved and entropy is increased. The position of the ring with these formed nodes gives the reaction products their fullest opportunity to enter the generator 125. This controls the efficiency of the reaction.

The nodal arrangement of the charges 70 in the fuel ring is not the same as the arrangement of the nuclei or charges in the conventional thermonuclear arrangement. With the conventional, thermal approach, the nuclei are moving randomly, whether at high or low density. The number of nuclei in the classical, thermal approach is extraordinarily high compared to the number of nuclei in each node. The thermal approach provides no method for magnetic moment alignment. Finally, the use of the momentum of the charges is used in the thermal approach to dominate Coulomb repulsion and to tear apart the nucleus through a chance distribution, as opposed to using the momentum of the nuclei relative to a magnetic field environment for controlled charge partnership, as achieved in the present invention.

In the present invention, a “non-thermal” approach is employed. Alpha particles 270 are created in the reaction chamber 122, as shown in FIGS. 24, 25 and 33A. In practice, each ring will differ. One ring will be minutely larger or smaller than its neighbor, and therefore each radius will be slightly different. The concave geometry of the magnetic fields (B), self-regulates the position and time of the reaction of each step-wise fuel ring, and each ring reacts individually with respect to these variables.

At the time of reaction, the nuclei 70 of the fuel ring 85 are organized and energized by acceleration and compression, where their controlled momentum brings them to the fusion density. Their geometric organization cancels out the majority of the Coulomb repulsion. The fuel ring 85 is further divided equally with respect to its circumference into many “high-density nodes.” Each node has a small fraction of the total number of nuclei that comprise the fuel ring. This is due to the inherent frequency of the ring itself and the imposed frequency to equalize the energy of the spins with respect to the precession of the nuclear magnetic moments of the acting individuals. These nuclear magnetic moments further act to neutralize the Coulomb repulsion between each nuclei in the fuel ring, which again increases the probability of reaction. The tremendous Coulomb repulsion between nuclei is completely neutralized by geometry and nuclear resonance with the only repulsion existing across the ring as described. The relative linear momentum of the nuclei break the barrier of Coulomb repulsion, due to the geometric rate of change of ring radius reduction in the reaction chamber. This “spiral formed fuel unit,” referred to herein as the fuel ring, is held in place by the geometry of the external three-dimensional magnetic fields. All the nodes around the fuel ring react and the resulting alpha charges enter the generator 125, shown in FIG. 33A.

III. The Fuel Ring

The fuel ring 85 consists of ⁶Li nuclei, which are charges 70, placed one behind the other in the form of a circle. This is not unlike a string of beads laid out in a circle, except that the ⁶Li charges rather than being held together as beads on a string, repel each other because of each of their positive charge. The repulsive force on each of these charges with respect to all of their neighbors is controlled by their movement through the magnetic field (B). This relationship is somewhat like an idealized airplane wing, moving through the stationary stratosphere.

The majority of the repulsive force between the ⁶Li positive charges is controlled by the geometric shape of the circular fuel ring 85, which cancels out much of this force. The remaining force is controlled by the ring and cumulative charge movement through the magnetic field (B). The charges 70 each have mass, and from their motion each has momentum. This magnetic field also controls this momentum, both angular momentum and relative momentum. Relative momentum is the charge to charge momentum, which is linear for the Coulomb force neutralized reactor system 45 of the present invention.

The movement of the fuel ring 85 is in three dimensions to counteract charge instabilities, which are also in three dimensions. This three dimensional movement is done by spinning the fuel ring, which takes care of two dimensions, and by moving the fuel ring perpendicular to the plane of rotation, which takes care of the third dimension. Each of the individual charges 70, in a large perspective, has a spiral trajectory, as shown in FIG. 33C. At initiation of the Coulomb force neutralized reactor system 45, the rotational direction of fuel ring is chosen with respect to the direction of rotation of the Larmor spiral of the nuclei around the summed magnetic fields (B) in the reaction chamber 122, to be compatible with the direction of the summed wave functions of the ⁶Li nuclei themselves.

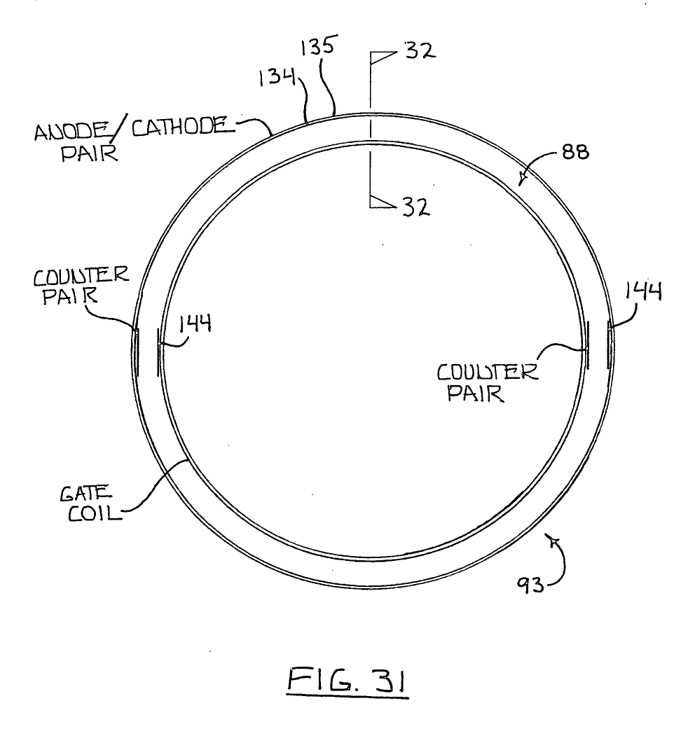

Specifically, in a preferred configuration of the accelerator 91, as shown in FIG. 1, the fuel ring 85 starts its formation at the accelerator, and completes its creation in the accumulator 93, as shown in FIG. 31. In the accelerator, the individual nuclei trajectories in the fuel ring 85 are each an expanding downward spiral that terminate in the accumulator, which then marks the beginning of the compressor 92, as shown in FIG. 21. In both the compressor phase and the reactor phase, the trajectory is a declining downward spiral, as shown in FIG. 33C. This spiral is created by moving the plane of the fuel ring, or plane of rotational movement, perpendicular to the rotation of the fuel ring.

In every sequence of positions that the fuel ring 85 experiences, the rate of change of its radius, linear and angular velocity, linear and angular momentum, and distance between its charges 70, are dynamic, which is a requirement for dynamic stability. This is also a requirement for a density and momentum level to penetrate the energy shell of the ⁶Li nucleus, where the strong force dominates the electric repulsion. This penetration allows the ⁶Li nucleus to move to a lower potential energy stability.

IV. Generation of the Fuel

Converting the ⁶Li atom to the ⁶Li nucleus or charges 70, and then into the alpha particles 270, first includes the removal of electrons through ablation and acceleration. The formation, accumulation and sizing of the fuel ring 85 is accomplished, followed by ring compression and acceleration with magnetic moment node formation. Finally, alpha particle and product electrons are produced for electrical production. To achieve these steps, several features are preferably included in the pre-reactor 50, of the present invention.

A first of these required features is an internal vacuum throughout the entire flow through the pre-reactor 50. Without the vacuum, air molecules will get in the way of the fuel nuclei 70 and destroy their trajectories. A second feature is that electrical energy is the source of nuclei manipulation through the use of magnetic fields (B) and electric fields (E). A third feature is that the magnetic and electric fields used are not uniform in all dimensions. A fourth feature is that the current amperage through the magnetic field coils 84 of the pre-reactor is constant, in keeping with Lenz's Law. A fifth feature is that, centered vertically throughout the entire magnetic and electric environment, is a central conductor 140, as shown in FIGS. 21, 26, 27 and 29, which radiates a circular magnetic field 141, for the entire length of the Coulomb force neutralized reactor system 45, as detailed in FIG. 29.

To achieve these preferred features, as listed above, an initial step is to remove the first electron from the ⁶Li atom to form the charged particles 70 or “ions” of the fuel stream 52. These charged particles can also be described as a “plasma” There are two conventional choices to energize these atoms to the level of 5.392 eV. First, this can be done thermally by heating and boiling the ⁶Li and then heating the gas with a RF tube to this energy level. The gas then becomes the plasma with this first electron removed by a positive electric field, conventionally generated by the RF tube. Alternatively, raising the energy level of the ⁶Li atom is preferably accomplished by employing other methods conventionally employed in plasma propulsion engines. Very small amounts of the ⁶Li on the surface of the fuel are energized with a pulsed electron beam that knocks the first electron away from the atom. The plasma then is injected into a magnetic chamber where the electrons are removed and the ⁶Li ions are available as the fuel stream, to enter into the accelerator 91, and become the fuel ring 85.

For the present invention, the accelerator 91 consists of a series of pairs of coils 107 that are preferably teardrop in shape, as shown in FIGS. 28A and 28B. These pairs of coils are arranged around a circular pattern, as shown in FIGS. 5A and 5B. To illustrate the principle, if a coil was a perfect circle, then on the plane of the circle, the magnetic field (B) generated when a current is applied to this hypothetical coil would have a uniform density. On this plane, within the coil, the (B) field is all the same. If a second hypothetical coil, the same as the first coil, is placed above this first coil as a pair and is equally energized, then the field between them is still uniform.

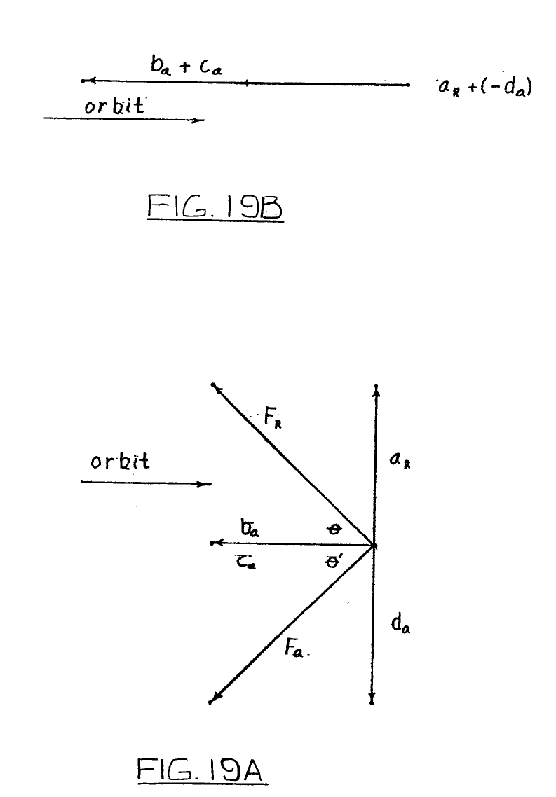

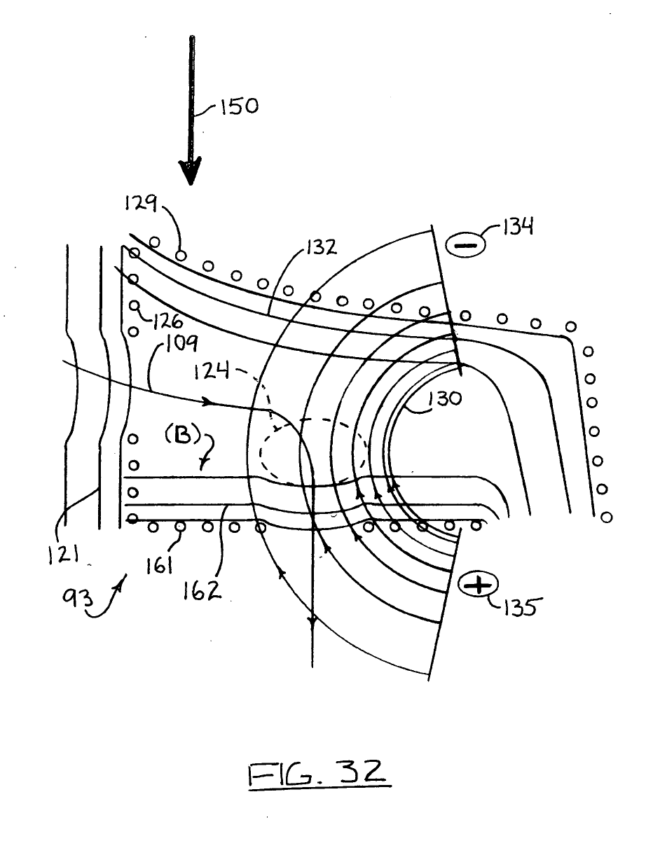

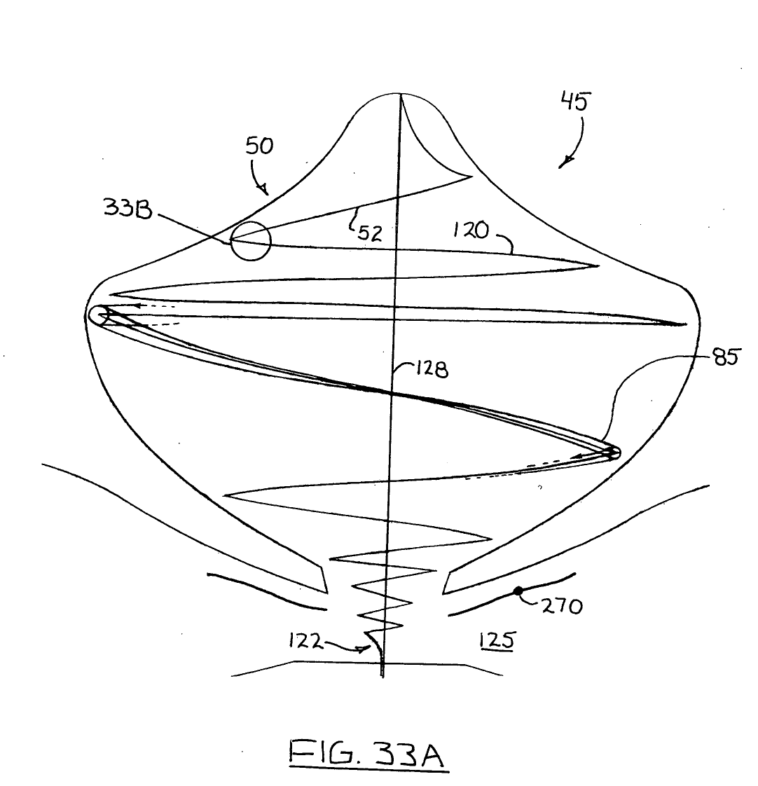

The top of the accelerator 91 and the chamber of the accumulator 93, both include a top coil 151, which are preferably flat in form, as shown in FIG. 1. The top coils are parts of the solenoid coil 129, which creates the accelerator's solenoid magnetic field (B). This solenoid field is radial in shape, as shown in FIG. 24, and is similar in form to the spokes of a bicycle wheel. This radially shaped field holds the upward vector a_{R}, as shown in FIGS. 19A and 19B, of the charges 70 in check, as shown in FIG. 32.

In the accelerator 91, with its use of segmented radius reduction and overall radius expansion, the ⁶Li nucleus charges are generally spiraling outward. Preferably, the spinning fuel ring 85 is as two-dimensionally flat in form as possible. This can be achieved by moving the plane of the ring perpendicular to the outward spiral. This vertical compression is possible because of a downward variable vector 150 of the spiral top coil 151, as shown in FIG. 1 and in the final accumulative position, an upward ejector vector 160, as shown in FIG. 32, generated by an ejector coil 161. The vertical compression in the accelerator is also the result of the seemingly contradictory conclusion of trajectory expansion at an increasing angular velocity.

Upon entering the accelerator 91, the fuel stream 52 forms the spinning, flat and rotating fuel ring 85. The bottom of the fuel ring expands faster than the top because of the shape of the solenoid magnetic field, which varies the vector forces upon the charges that make the fuel ring.

As is shown by the Law of Conservation of Angular Momentum the angular velocity at the bottom of the cylindrical fuel ring 85 has a slower rate of increase in acceleration than the top of the cylinder. This process continues with the downward movement of the fuel ring. The cylinder flattens vertically and its density increases even though its radius increases. To maintain equal density while flattening the cylinder would require a very large radius. Centripetal force and Coulomb repulsion across the rotating fuel ring does this work. The spiral cylinder of the fuel ring becomes a very small volume toroid, which can be described as a “spinning ring filament,” and is shown in FIGS. FIG. 1, and 33A through 33D.

The purpose of the accumulator 93, as shown in FIGS. 30, 31 and 32, is to count and define the number of charges in the fuel ring 85, refine the angular velocity, and eject the formed, refined fuel ring into the compressor 92. It defines the number of charges in the ring by interrupting the flow of charges entering into it from the accelerator 91. This is achieved with a gate coil 126, shown in FIGS. 31 and 32. The gate coil is a solenoid that is turned on and off when a counter pair 144 triggers it after a predetermined number of charges are sensed. This number is found by demand within limits of capacity of the Coulomb force neutralized reactor system 45.

As shown in FIG. 32, when this gate coil 126 is on it creates a gate solenoid field 121. The gate solenoid field is added to the radially shaped, general solenoid field 116, which is a general, over-encompassing field shown in FIG. 24. The general solenoid field is on continuously during operation of the Coulomb force neutralized reactor system 45. When activated, this small, localized gate solenoid field stops the charges 70, from entering the accumulator 93. When this gate solenoid field is turned off, the charges move outward and into the accumulator from the accelerator 91.

After entering the accumulator 93, these charges 70 must be counted, their energy maintained, and their angular velocity refined. This all must be done within three-dimensional containment. The accumulator has a circular accumulator volume 124, as shown in FIG. 32. Within this ring of circular accumulator volume, the charges rotate. At an appropriate position inside and outside this circular ring is the counter pair 144 of the accumulator 93, as shown in FIG. 31, of the same principle as the accelerator coil pair 107 shown in FIG. 28A. The counter pair creates a magnetic field (B), as shown in FIGS. 28A, 28B, and 32, within its coil boundary, which is perpendicular to the radial, general solenoid field 116 of the present Coulomb force neutralized reactor system 45. As the number of charges build in the accumulator 93, more current is needed to keep the magnetic field between these coils constant as shown by Lenz's Law. This difference in current is measured and determines the number of charges. The number of charges is pre-determined, and when this number is reached, the gate solenoid field 121 to the accumulator is closed. This counter technology is known to those skilled in the technologies of charge counting fields. The geometry of the gate solenoid field also accelerates those charges that have a tendency to have cyclotron energy losses, and so the gate solenoid field, generated by the gate coil 126, maintains and refines the angular velocity of the charges in the volume of the accumulator.

Containment of the fuel ring 85 within the accumulator 93, for the most part is accomplished by the general solenoid field, as shown in FIGS. 24 and 32, as it transitions from the accelerator 91 to the compressor 92 of the pre-reactor 50. The accumulator is located in the transition between the accelerator and compressor sections. Containment of the charges 70, especially in the accumulator, is further controlled with a combination of the electric fields (E), and the magnetic fields (B), as shown in FIG. 32. These fields give control in the vertical, or (y) dimension, while the (x) and (z) dimension are controlled by the general solenoid field 116.

As shown in FIG. 32, the accumulator 93 has a spiral shaped coil, which is a segment of the accelerator solenoid coil 129. The magnetic field (B) that it produces, creates a downward vector force 150 on the charges 70, as they rotate perpendicularly through this field. This downward force is equalized by the upward vector force 160, created by the ejector coil 161. An electric field is created by a ring anode 134 and a ring cathode 135, which are shown in FIG. 31, with this field generated between them, as shown in FIG. 32. The ring anode is at an angle from the vertical and positioned at the bottom outside corner of the accumulator. Its counterpart, the ring cathode, is of similar angle from the vertical and positioned at the top and outside corner of the accumulator. The electrical field (E) then extends as shown in FIG. 32, from the anode to the cathode in a circular volume with its greatest vertical angle at an accumulator center 130 of the accumulator.

The particles, or charges 70 in the accumulator have a positive charge of three (3), and therefore in the presence of this electric field (E), the ⁶Li particles have a tendency to move away from the positively charged ring anode toward the negatively charged cathode. Therefore, there is equilibrium in the accumulator with respect to all three dimensions and energy restoration due to cyclotron energy losses. This stability remains until a counter 144, or detector of conventional design and well known to those skilled in applied particle physics, decides that the ring has reached its proper, predetermined size.

The “floor” or base of the accumulator 93 has one other spiral coil in addition to the anode 134 at the corner of the accumulator. This is an ejector coil 161, which moves the fuel stream 52 out of the accumulator, as shown in FIG. 32. The ejector coil is divided to give room for the fuel ring to pass. Preferably, the ejector coil is off, while the fuel ring is forming in the accumulator 93, and the fuel ring is in a dynamic equilibrium. When the counter 144 and its detection field has fulfilled its set values, the ejector coil is energized, and the electrical field (E) is turned off. The ejector coil field 162 it creates in the accumulator has the same alignment and flux as the top spiral accumulator or solenoid coil. As the charges 70 now rotate through in a trajectory 109, which is preferably perpendicular to this strengthened ejector field, the downward vector force 150 moves the fuel ring 85 out of the accumulator and into the compressor 92. As the ring passes beyond this coil it experiences an upward vector force from the slightly curving, general solenoid field 116, which is overcome by the downward vector force of the radial fields in the compressor section which moves the fuel ring downward.

V. The Magnetic Field

The purpose of the magnetic field (B) in the present invention is to control the repulsive force between the charges 70, which is not canceled by the charge's geometric arrangement. If one could actually view this field as experienced by the fuel stream, the magnetic field would be a three dimensional spiral, as shown in FIG. 33A, B, C, and D. In the accelerator 91, the magnetic field is an expanding three dimensional spiral in the compressor 92, and the reaction chamber 122 is a declining three dimensional spiral. As the charges move through this steady field geometry, the field controls the charges' repulsive and momentum forces by virtue of the charges' individual positions in the field.

This control can only be achieved if the charges 70 experience a change in the magnetic field (B), as they move through the field. The three-dimensional magnetic field is non-uniform. Each dimension is not only not uniform with respect to itself but also not uniform with respect to the other two dimensions. The rate of change of the dimensional ratios of the magnetic field with respect to its direction and density is determined by the position of the charge in it. If one could slice the field and view the resulting field surface, thereby removing one of the dimensions, there would be seen uniformity in the rate of change.

From the outside, or on a larger “macro” perspective, the charges 70 in the fuel ring 85 seem to follow one another in a line, but from an inside, or a smaller “micro” perspective the charges are rotating with respect to each other, as shown in FIG. 33B. For example, if one could “sit” upon a particular charge (P), revolving in the idealized ring 61, and look at the charge ahead, one would see that charge orbiting in a small circle, perpendicular to the direction of movement of the charge that one was sitting on. As the actual fuel ring compresses in its procession toward the reaction chamber 122, the charge ahead would be spiraling at you head-on at an increasing rate, with a relatively equal linear velocity and linear momentum, as you gain velocity and angular momentum. Of course, the charge you are sitting on is rotating and moving in three dimensions also. The spiral magnetic field is the sum of each of three magnetic contributions, and each contribution is a dimension “extension.” Each one of these dimension extensions has a three-dimensional volume of its own and is defined by having direction. Because the directions are curved, they overlap into the other two dimensions. These are the parameters for modeling this field with three-dimensional calculus. Each magnetic dimension and the conductors that produce it can now be described.

VI. Applicable Magnetic Fields and their Vectors

Other than the magnetic fields (B) discussed above, which serve as “gates” in the general solenoid field 116 of the accelerator 91, and in the ejector coil field 162, the magnetic fields (B) throughout all the main parts of the Coulomb force neutralized reactor system 45 have some similar characteristics. These fields that the charges move within, all work in partnership with one another. All the fields are present everywhere throughout the entire system. The extent of their effect on the trajectory of the charges can be found in the Bio-Savert Law. In all cases, in the accelerator 91, the compressor 92, the reaction chamber 122, and the generator 125, the guiding center drift of the charges is predetermined by the opposing vector forces and their balance as a result of the generally perpendicular (i) crossing of the fields which then become additive. In every case the direction of the trajectory of the charges crosses all three of these crossing or additive fields so that the charges do not flow parallel or perpendicular to any but cross the sweep of all. From the other point of view the trajectory is both parallel and perpendicular at the same time.

In all cases the magnetic fields (B) are non-uniform with respect to the charges' angular velocity and angular position with the magnetic fields having a specifically designed geometric shape. Their rates of change relative to one another are deliberately unequal to control movement of the guiding center drifts of the charges. Without this control, nothing would take place. The charges would start wandering and the orbits would change into random shapes.

In each of the magnetic fields (B), there is a departure in shape from the expected. No coil can be wound perfectly. According to Faraday's principle of induction, as formulated in Lenz's Law, a reverse magnetic field is induced in any magnetic field by the movement of electric charges through it. Therefore, the amperage for the magnetic fields of the ring chamber 88 must be counteracted to keep the summed field always at an expected, required intensity. Because of the movement of the charges in the cumulative three-dimensional magnetic field (B) environment, discrepancies are smoothed over so that the overall pathway of the fuel ring 85 can be predicted.

To set up the vector forces in the present description, the direction of movement of the positive charges is set to be clockwise, and the right hand rule is naturally employed to determine the direction of the force relative to the direction of the angular velocity of the charges. Even though the right hand rule is used, because of the non-uniformity of the fields, the “sin θ” in the expression F=qvB sin θ, is required and the vectors are additive. There are three magnetic fields (B) enveloping the ring chamber 88. The most familiar type of field is a solenoid field.

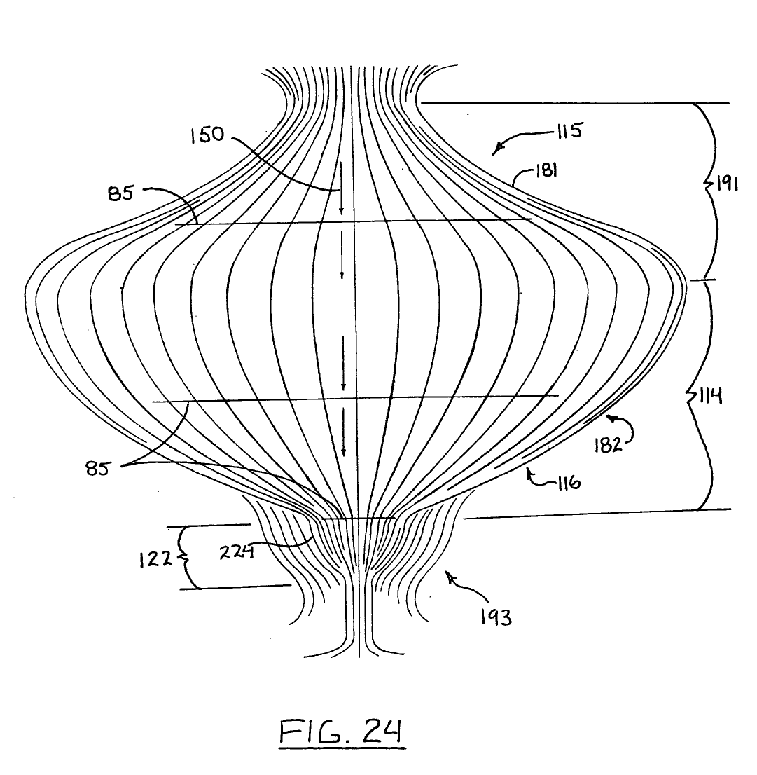

A solenoid magnetic coil winding 129, shown in FIGS. 22A, 22B and 32, around the compressor section of the ring chamber 88 makes the solenoid field 114 in the appropriate geometry. It is a solenoid field 116, which is for the most part parallel to the central vertical axis 128 of the entire Coulomb force neutralized reactor system 45. This central vertical axis is often referred to herein as “vertical” as a preferred orientation and for discussion purposes in reference to the drawings, with the understanding that the reactor system of the present invention could be oriented with the central axis in any direction in an alternative embodiment, as shown in FIG. 23. The nonuniformity of the entire solenoid field, in general, and specifically the exterior surface of the pre-reactor 50, is characterized as having a concave shape 181 in the accelerator 91, curving inward, toward the central vertical axis of the accelerator. In the compressor 92, the solenoid field has a convex shape 182, curving outward, away from the central vertical axis of the compressor, and transitioning into the reaction chamber 122, as shown in FIGS. 1 and 21.

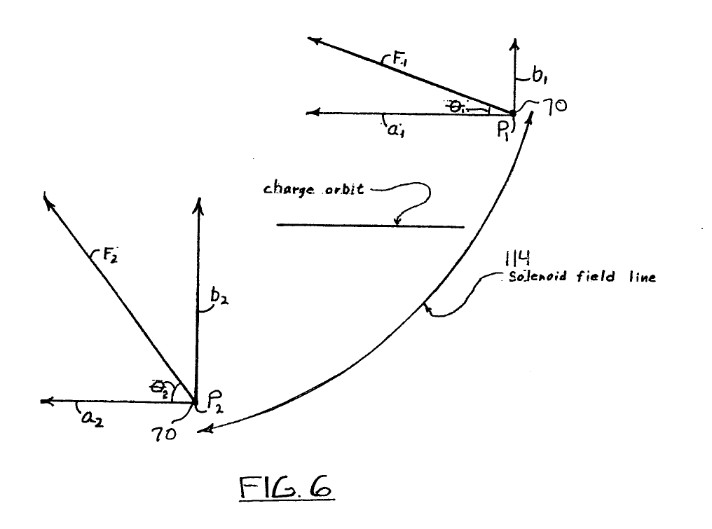

In the compressor 92, the widest part of the solenoid field is at the top of the compressor, and the narrowest part is at the bottom of the compressor. In this arrangement, the field strength is less at the top of the compressor than at the bottom. The flux of this field is from bottom to top with the field direction upward. The force on the charges 70 moving through this magnetic field (B), is toward the center of the Coulomb force neutralized reactor system 45. The magnetic field is not uniform, in that it has an increasing intensity. For the magnetic field, there is always an inward vector force a₁ and a₂, paired with a respective, upward vector force b₁ and b₂, as shown in FIG. 6.

As also shown in FIG. 6, the inward vector forces a₁ changes to a₂ as the positive charge 70 in a position P₁ moves to a position of P₂. The positive charge moves along the compressor solenoid field 114 in the compressor 92, relative to the curvature of the field. The resultant effect is that as the positive charge spirals through the solenoid field, the inward vector forces decrease and the upward vector forces, b₁ and b₂ increase. This decrease in the inward vector is not an absolute decrease, but a relative decrease. As the position of the positive charge in this solenoid field moves into the greater intensity region, its transient velocity increases and the field intensity increases. The angle of rotation of the positive charge through the field keeps declining to smaller radii from the perpendicular. This same reasoning also predicts and explains the corresponding increase in the upward vector in the solenoid field.

VIa. The Solenoid Field

As shown in FIG. 24, the general solenoid field 116 runs substantially at a vertical orientation through the entire Coulomb force neutralized reactor system 45, and includes three sections. The sections are the accelerator solenoid field 191, the compressor solenoid field 114, and the reaction chamber solenoid field 193. If the conductors that makes the solenoid field were turned on alone, the field would look very much like the central conductor 140, and in fact would be parallel to it in every section. In the compressor 92, this solenoid field is perpendicular to the stacking of the coil windings of the solenoid coil 152, shown in FIGS. 22A and 22B, of its conductor.

As also shown in FIG. 24, the accelerator solenoid field 191 is narrow at the top and expands outward toward the location of the accumulator 93, and has a convex shape 181 as an inwardly curved cone. This wide part of the general solenoid field 116 continues down through the compressor 92, where its shape is just the opposite. The compressor solenoid field narrows at its bottom and has a concave shape 182, as an outwardly curved cone. As the solenoid field approaches the bottom of the compressor and beyond or through it, the solenoid field becomes more dense. At this location the field continues to narrow with only a slight departure from the vertical. This slight narrowing is very important feature, in that it maintains the building or increase of the relative linear momentum of the charges 70, conducted by the field. The solenoid field then continues on into the reaction chamber 122, as shown in FIGS. 21, 28, 29, 33A, 33B and 33C, where it further narrows, responding to a solenoid flux concentrator 211, preferably at an angle approaching horizontal, and most preferably within 45 degrees of horizontal. In a preferred embodiment of the present invention, the solenoid field then continues on through the center of a second pre-reactor 212, as shown in FIGS. 23 and 33D, which includes all the component elements and generated fields of the pre-reactor 50. With the internal, relevant shape of the solenoid magnetic field, the magnetic field's “circuit” is completed with the external part of the field attaching itself to the top of the field as it enters the top of the accelerator 91. In the accelerator the vector force on the charges from the solenoid field cause the charges to move to the greatest extent downward through the accelerator, and to a smaller extent inward toward the accelerator center 100. This movement of the charges is the result due to the very flat angle of the field with respect to the vertical dimension.

In the compressor 92, the vector force begins with an inward force. As the fuel ring 85 moves down through the compressor, the angle of the field changes and the vector force has an increasingly upward component along with the inward component. The density and strength of the field increases as the ring moves through it.

As the ring transitions between the compressor 92 and the reaction chamber 122, the solenoid field vector force is again dominated by the inward direction. At the top of the reaction chamber this field has a slight upward vector and a dominant inward vector. At the bottom the vectors are substantially upward and inward.

VIb. Radial Field Description

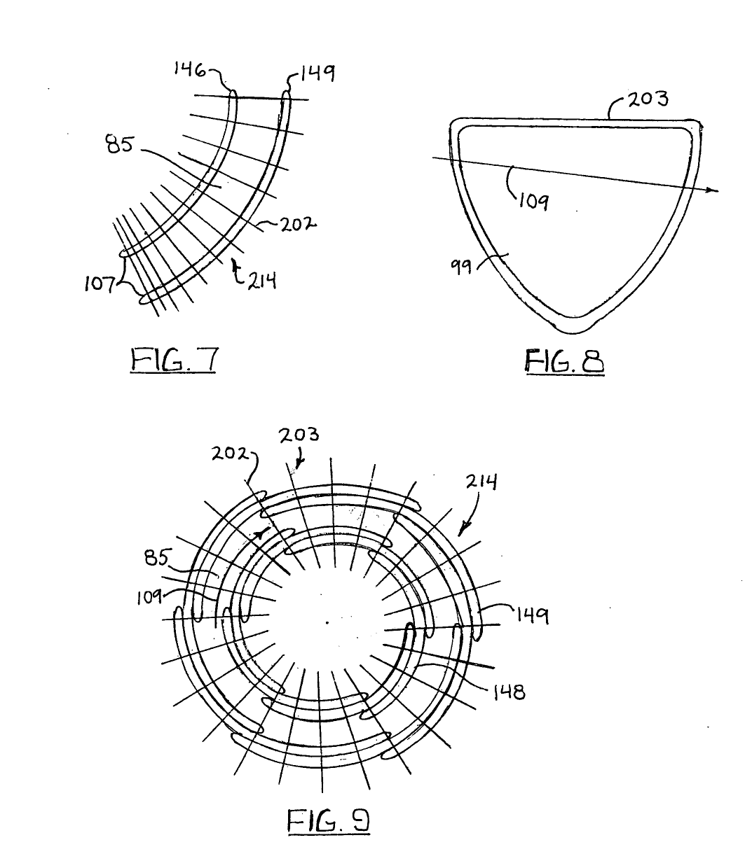

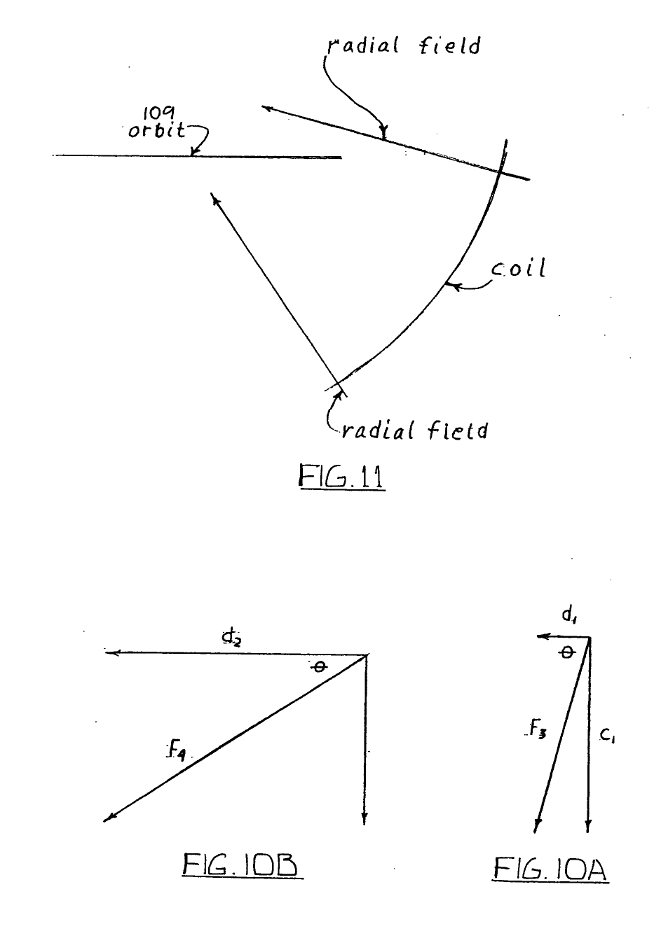

The second essential magnetic field (B) in the ring chamber 88 is the radial field 202. There are some real opportunities in designing this field because of the increased number of variables available compared to the simple, spiral shaped top coil 151 and the solenoid coil 152 for the general solenoid field 116. This field is created by a surrounding series of paired triangular coils, as shown in FIGS. 7, 8, 9, 28A and 28B.

Most preferably, these compressor radial field coils 203 overlap, as shown in FIGS. 9 and 35, so that the compressor radial field 119 is as even as possible. The flux of the field is from outward to inward so that the vectors are inward and downward relative to the rotation of the positive charge. FIGS. 10A and 10B show the vector components of the compressor and reaction chamber radial field. Comparing again the vector force of d₁ and d₂ as well as c₁ and c₂, there is the change of force. Also of note is the change of F₃ to F₄ in both angle and intensity to the orbit of the positive charges. The change of intensity is required for induction and for work to be done on the positive charges.

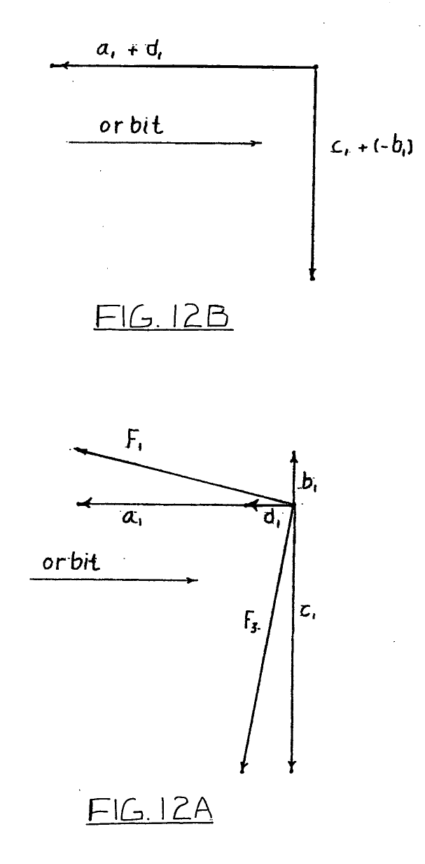

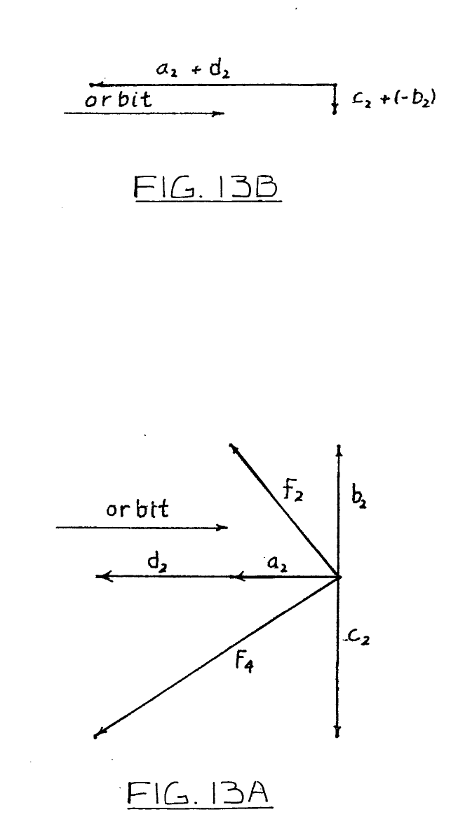

By looking at the vectors and their changes from both the solenoid fields 114 and radial fields 119 in the compressor and reaction chamber, there are some interesting, preferred additions. When the vector components a₁ and b₁ from the solenoid field that give F₁, are added to the vector components d₁ and c₁ from the radial field that give F₃, the inward force total a₁+d₁ increases, because their force is a result of a₁ and d₁ being both in the same direction. When b₁ is added to c₁, it is an opposing situation because of the opposite directions. Because c₁ is larger than b₁, there is downward movement of the charges, as shown in FIGS. 12A and 12B, which is the vector result of adding F₁ and F₃.

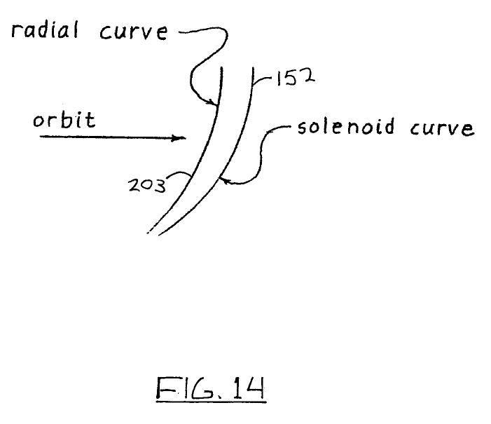

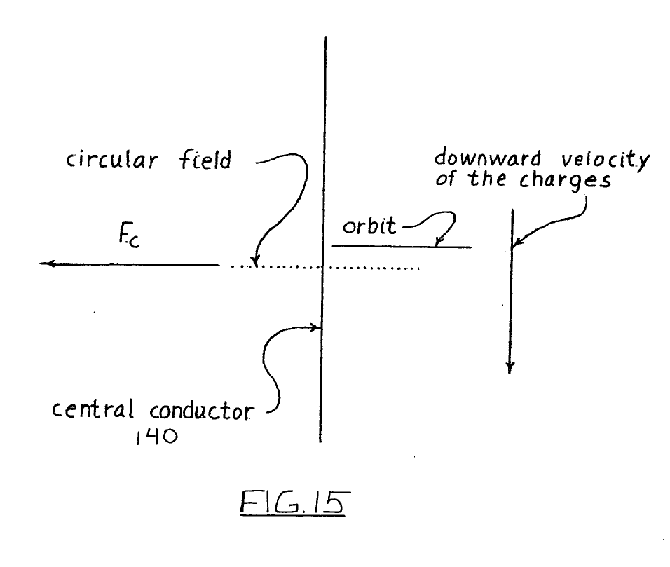

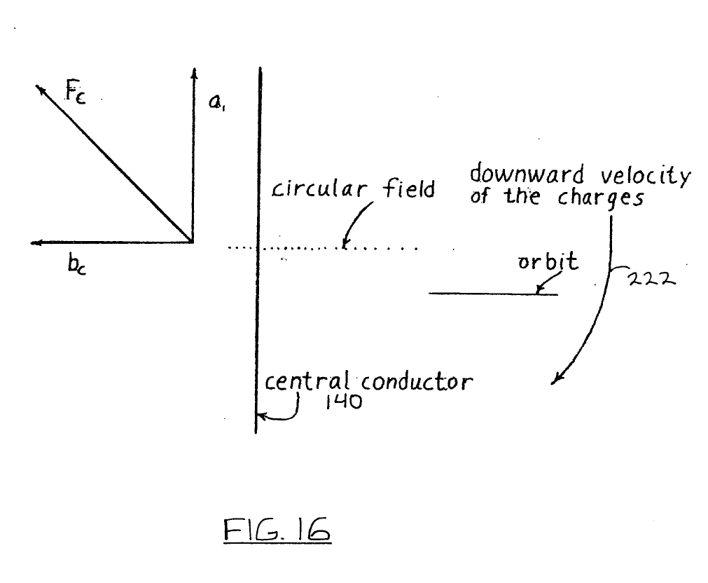

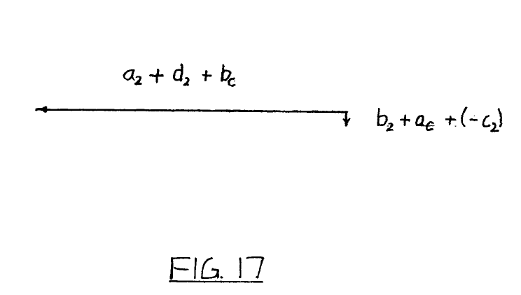

Continuing with the addition of F₂ and F₄, a similar result occurs, but reflects the different values. As shown in FIGS. 12A, 12B, 13A and 13B, the downward vector sums of the F₁ and F₃ forces, compared to the sum of the F₂ and F₄ forces, illustrate that as the positive charges spiral downward, the downward velocity decreases. The guiding center, which is the same for all the positive charges in a macro perspective, has a downward velocity deceleration. This variable rate of deceleration is controlled not only by the curve of the coils but also by having an unequal rate of change of curve of the compressor solenoid coil 152, with respect to the compressor radial coil 203, as shown in FIG. 14.

Again, this description is relevant only if the other two dimensional fields are turned off. In all positions in the accelerator 91 and compressor 92, the radial field 202 is perpendicular to the solenoid field 116, if the radial compressor field 119 is energized. An inner compressor radial coil shell 57 is formed at the interior surface of the solenoid field, as shown in FIGS. 1, 21, 22A, 22B, 25, 30 and 35. The radial field, with its downward force vector, exists in the reaction chamber 122, by extending the inner compressor radial coil shell, to form an extended inside surface 74, of the compressor radial coils, as shown in FIGS. 1 and 21. The radial field with a downward vector force 213 extends into the reaction chamber 122, as shown in FIGS. 1 and 25. The varying accelerator field density 214, as shown in FIGS. 5B, 7, 9, 28A and 28B in the accelerator, is responsible for increasing the angular velocity of the fuel ring 85. Each radial field is not straight through its paired loop-conductors, but preferably includes a field bulge 199 outward between them, as shown in FIGS. 18 and 28B. The effect this has on the charges 70 in the fuel ring helps stabilize their trajectory in that dimension.

The vector force applied by this compressor radial field 119 in the compressor 92 and reaction chamber 122 moves a plane of rotation 220 of the fuel ring 85, parallel to the vertical central conductor 140. Because of the angle of the radial field in the compressor and reaction chamber, the vector forces on the charges are downward and inward, as for the accelerator 91 described above. The down vector force on the ring must be greater than the up vector of the solenoid field so that the ring will continue through the compressor. In the compressor, this field increases the density that matches the need for an increasing outward ring force as well as increasing the relative linear momentum of the charges 70. This gives the downward vector 213, which is sustained on the positive nuclei charge.

As shown in FIGS. 12 and 13, the opposite direction of b₁ to c₁ and b₂ to c₂, not only controls the guiding center drift, or the Larmor orbit of the positive charges 70, but also help in controlling the amplitude of the wave of the positive charges. This helps guide the charges to their lowest potential energy position with respect to the other charges in the ring.

When a positive charge moves to a higher position than the plane of the fuel ring 85, it is in a radial field of greater downward force as shown by comparing c₁ to c₂ and therefore will move down and back into its lowest potential energy position. When a charge moves to a lower position than the plane of the ring, the charge is in a solenoid field of greater upward force. This is shown by comparing b₁ to b₂. As a result, the ring will catch up to the charge, and the charge will again attain the lowest potential energy position.

The inward vector sums of F₁, F₃ and F₂, F₄ maintain the charges in their circular trajectory. These vectors are in the same direction. For example if a total of 0.8 Tesla is needed to define a Larmor radius of a charge of a transcendental velocity value then the compressor solenoid field 114 would be a fraction of 0.8, while the compressor radial field 119 and the circular field 141, further discussed in the following section, would be the remainder. This certainly is helpful in the fabrication of the magnets, since each one is not required to be as large as in conventional fusion systems.

When a positive charge moves inward from the ring it experiences an increasing repulsive electric field from its neighboring charges and an increasing transcendental velocity. The increasing angular velocity, interacting with the field, will push the particle downward where it again encounters an increasing upward solenoid field and the ring catches up to it and the charge returns to its lowest potential energy position.

When the charge moves outward of the ring its transcendental velocity slows as described by the law of conservation of angular momentum and it moves upward where it encounters an increasing downward radial vector. Again the charge returns to its lowest potential energy position.

VIc. The Circular Field

A third magnetic field (B) that exists in the chamber is the circular field 141, as shown in FIG. 29, which surrounds the central field conductor 140, as shown in FIGS. 26 and 27, created by the amperage in this vertical conductor that stretches down the center of the entire Coulomb force neutralized reactor system 45. Its contribution to force on the charges 70 is similar to that of the solenoid and radial magnetic fields (B) and is added to them. It provides the third element for a three-dimensional magnetic environment. However, the vectors on the charge from this circular field are not due to the circular angular velocity of the ring but due to the downward movement of the fuel ring 85 that is perpendicular to the rotational plane of this angular velocity. This magnetic field (B) causes a response to a vertical angular velocity 222 of the nuclei in the fuel ring, as shown in FIG. 1 and 16.

The charges in the fuel ring 85 cross this circular field 141 in their vertical pathway downward. The vector can be shown as a result of this event. At the top of the compression chamber the downward velocity is vertical and thus the vector F_{c} is inward, as shown in FIG. 15.

Again, this above description is relevant only if the other two fields are turned off. If the solenoid field and radial fields were turned on, this circular field would be perpendicular to both. The density configuration for this field has an approximate constancy from top to bottom because the conductor is expanded to match the geometric configuration of the solenoid field. The radius of the shell of this field follows the outside volume of the general solenoid field 116, as shown in FIG. 29.

The vector force exerted on the charges 70, as they move downward through the circular field 141 is inward, and the strength of the field has two components. The primary strength remains constant and has laid over this an additional pulsed strength. This is to provide one of the “nuclear magnetic resonant,” or NMR aspects in the reaction chamber 122.

As the charges of the fuel unit move further down the compression chamber the vector forces change and give both an inward b_{c} and upward a_{c} components. Not only does the vector F_{c} appear, but also its strength changes with respect to the distance from the conductor, the angle of encounter with the field, and the velocity of the encounter as described by the Biot-Savart Law, as shown in FIG. 16.

The components of F_{c} are added into the components of FIG. 13, with the result as shown in FIG. 17. As the charges move with respect to this field they not only cross it vertically but also cross it as they get closer to the central conductor. This force is small and is added to the b₂ and c₂ components of FIG. 17.

The shape of the summed magnetic fields (B), as seen by the charges, is a downward spiral field concentrating in the generator with the charges following the geometry of the spiral. Coils of the accelerator and the curl of the exiting solenoid and radial fields from the ring chamber 88 generate the vector forces on the positive charges in the ring chamber 88. The upward flux of the accelerator radial field 117, compressor radial field 119, and general solenoid field 116 is in the same direction as the upward flux of the fields of the accelerator, as shown in FIG. 25.

VId. Injection Field

The injection field 235, as shown in FIG. 25, has the same function in the reaction chamber 122, as the compressor radial field 119, and that is to produce the force of the downward vector 213 on the circular moving charges 70. This downward vector force is strengthened by extending the inner compressor radial coil 74 into the reaction chamber, and so extends the compressor radial field into the top of the reaction chamber to strengthen the downward vector of the fuel ring 85. This increases the vertical angular momentum, linear velocity and linear momentum in response to the curl of the flux geometry of the solenoid flux concentrator 211 of the solenoid field 116.

The injection field 235 fans out underneath this concave winding and radiates into the reaction chamber 122. The injector field is perpendicular to the solenoid field 116 and the circular field 141. As is the case with the circular field, the injector field is a magnetic field with two parts. The primary strength remains constant and has laid over it an additional pulse strength at the same frequency as the pulse of the circular field. This completes the (NMR) requirement. The downward vector force of the injector field is matched by the upward vector force of the solenoid field at some place defined by the charges' position and angular velocity.

VII. Vector Forces in the Fuel Ring

The solenoid winding at the top of the accelerator creates a curved solenoid field (Bₛ) Its intensity is not only adjusted by the geometry and current but by the looseness of the windings. FIG. 19 shows the vectors as a result of the forces on the charges with respect to their interaction with these magnetic fields (B).

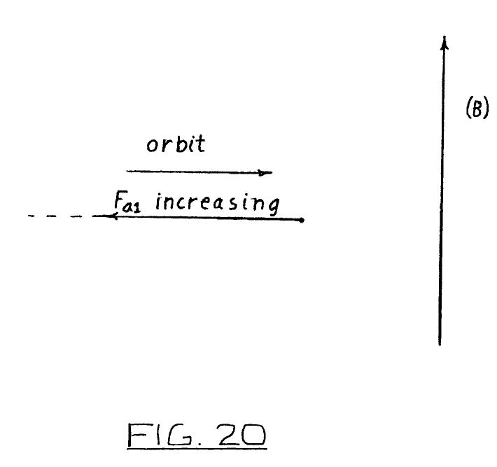

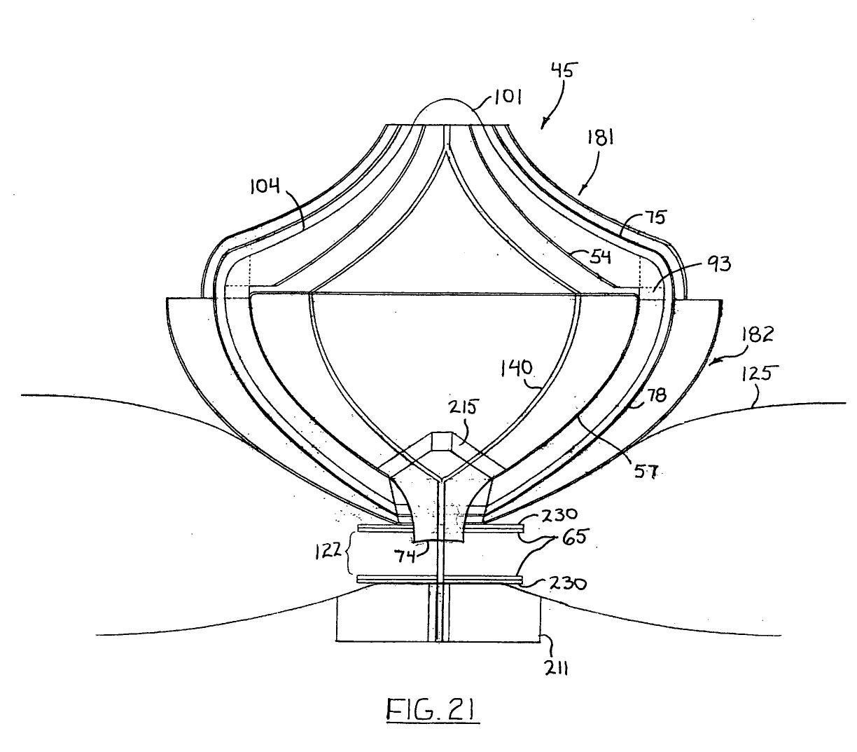

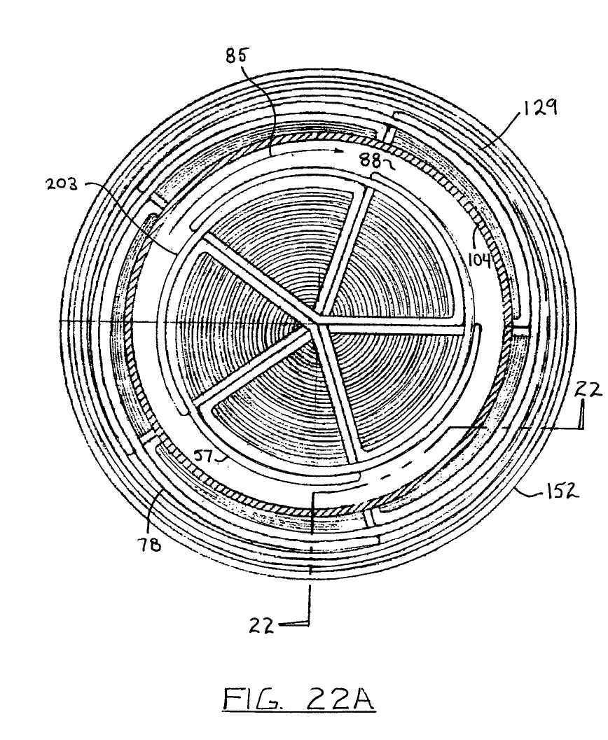

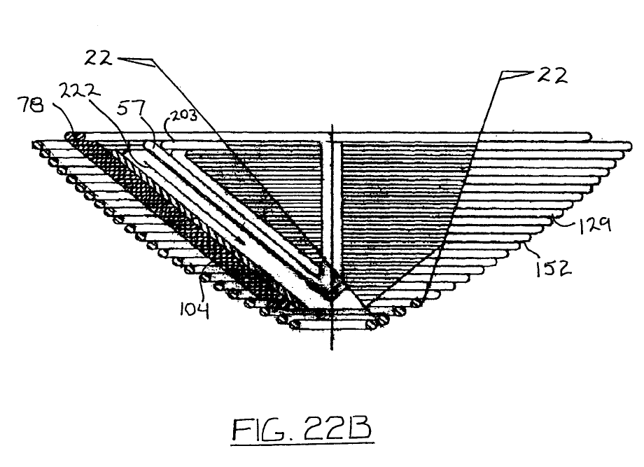

“F_{R}” is defined as the vector force from the solenoid coil generated magnetic field (B) and “Fₐ” is the vector force from the accelerator radial field 117. F_{R} and Fₐ are variable in both angle and magnitude depending upon the position of the positive charge with respect to the encountered (B) fields. FIG. 20 depicts this arrangement.

As discussed previously herein, the non-uniform paired coils 107 in the accelerator 91 are tear drop shaped triangular coils. As the positive charges 70 move through the created magnetic field (B) field between these shaped coils, the charges will experience an increasing vector force of Fₐ₁, as shown in FIG. 20.

With this understanding of the varying vector principles through the Coulomb force neutralized reactor system 45 of the present invention, it must be pointed out again that the sum of the fields creates a field that is a spiral in itself, as experienced by the charged nuclei 70 within them, as shown in FIGS. 33A and 33C. By varying the ratios of the amperages in the relative coils and vertical straight conductor, this spiral can have a changing shape that responds to outside need and internal variance. These varying ratios change the angular velocity of the charges and rate of fuel processing, to directly regulate energy output. The variable ratios also control nuclei resident time and the change rate of nuclei distance reduction for the merging nuclei, thereby affecting overall reactor efficiency.

Even if the fuel ring 85 reaches fusion density at the angular velocities that give the nuclei 70 sufficient energy levels for fusion, the entire ring can not yet react efficiently. As a toroid, the filament shaped fuel ring is susceptible to isolated fusion events at various points around the fuel ring. The resulting ring instability makes it impossible to produce efficient power. For this reason, the reaction chamber 122 of the present invention preferably includes unique principles of design, discussed as follows:

VIII. The Reaction Chamber

The reaction chamber 122 is the place where each of the nuclei 70 of the fuel ring 85 is transformed into an alpha charge 270, or alpha particle, as shown in FIGS. 33A, 36A and 36B. The reaction chamber is defined as that place just below the conductors of the compressor 92, and at the center of the generator 125. At the bottom of the reaction chamber is the solenoid flux concentrator 211, which produces an upward vector force on the nuclei and has a function to extend and flatten the end of the general solenoid field 116, at the bottom of the compression chamber through the reaction chamber, as shown in FIG. 24.

This solenoid flux concentrator 211 has a center radius opening that is much smaller then the opening at the bottom of the compressor 92, so that the magnetic field (B) curl does not bend outward at the top of the reaction chamber 122. The most ideal circumstance would be that this field's curl at this point is perpendicular (⊥) to the winding of the compressor solenoid coil. As shown in FIG. 24. As the magnetic field (B) approaches the center of the solenoid flux concentrator, it bends inward and concentrates more closely going through the coil.

The compression chamber injector coil 215 is located just above the bottom opening of the compressor 92, as shown in FIG. 21. It is a spiral flat coil that creates an injector field 235, as shown in FIG. 25, which is crossed by the trajectory 109 of the charges 70 at the bottom of the compressor. With the extension of the inner compressor radial coils 74, the downward vector 213 on the charges is added, which directs the charges out of the compressor. The upward and downward summed vector relationships of these two magnetic fields (B), route the fuel ring 85 into the reaction chamber 122, and drive the fuel ring downward, as the shape of the solenoid magnetic field 116 increases its intensity relative to the position of the fuel ring. In addition to its role in controlling the vertical velocity of the fuel ring as it rotates, this magnetic field (B) defines the general radius of the fuel stream. The fuel ring with its individual charges crosses this magnetic field with its inward and upward vectors.

The circular field 141 extends from the vertical conductor 140 in the reaction chamber 122, throughout the entire Coulomb force neutralized reactor system 45. In this chamber, the circular field has particular importance in stabilizing the trajectory of each nucleus as it is part of the fuel ring 85. At every place in the reactor system, each charge 70 must have its radiated cyclotron energy replaced. The accelerator 91 and compressor 92 accomplish this as part of the process of adding energy to each charge relative to its position in the field environment. The reaction chamber must have present a magnetic field environment that does this same thing and that is to be able to add energy to each charge relative to its position in that environment. As is the case in the accelerator and compression chambers, the charge in the reaction chamber receives an increase in energy relative to its position when the change of position puts the charge in a place of increased magnetic field density.

When the charge 70 in the reaction chamber 122 tends to radiate its cyclotronic energy, its orbital radius increases, and therefore to restore that energy it must enter a place that has an increased magnetic field density that reduces its radius relative to its angular velocity, mass, and charge. The increasing rate of radius reductions increases the relative linear velocity of the nuclei, giving increasing linear mass. This relativity improves the mass to charge ratio and increases the cross section of reaction. The same is true in the up and down position. The standard description of these places is the (x), (y), and (z) dimensions.

If a charge moves up it encounters an increase in magnetic field density that comes from the “curl” of the field, which is created by the bottom of the solenoid and radial fields, plus the curl of the injector field 162, as shown in FIGS. 25 and 32. The angle of this field with respect to the trajectory of the charge moves the center of rotation to its lowest potential energy position. The same is true when a charge moves below this position of lowest potential energy. The curl of the solenoid flux concentrator coil 211 relative to the charge cyclotron trajectory causes the charge to move up into the lowest potential energy position.

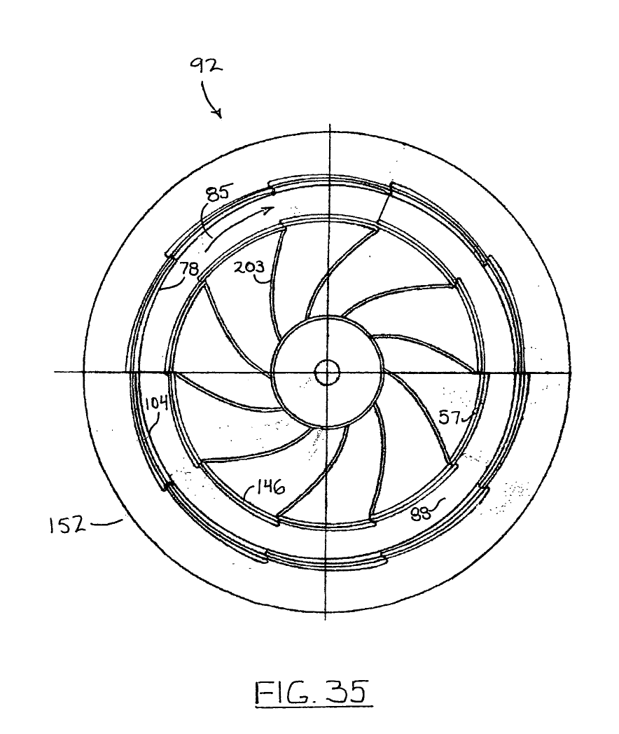

To create nuclear stability in the (x)-(y) dimension, the reaction chamber 122 must be provided with a similar arrangement as discussed above for the accelerator, with paired, skewed, tear drop coils 230, along with the circular series of coiled loops 65, each of decreasing volume, as shown in FIGS. 21, 34A, 34B, 36A and 36B. These are placed above and below and around the reaction chamber. The number of pairs can be small compared to those in the accelerator because the energy loss of the charges is very small before it is restored. The loss of energy is equal to the uncertainty of angular velocity and position of the charges. One half of each pair is positioned on the upper surface of the reaction chamber and the other half is positioned at the bottom of the chamber as part of the generator electrodes, as shown in FIGS. 21, 36A and 36B.

It might be expected that with this above described magnetic field (B) arrangement, the charges in the reaction chamber 122 would exhibit the tendency to lose energy. Instead, by design of the present invention, if they lose energy, their radius increases, placing their position into a high density magnetic field (B), which increases their angular velocity by reducing their radius and increasing their energy. This is a self-regulating stability for the Coulomb force neutralized reactor system 45. After reaction, the alpha charges produced by the Coulomb force neutralized reactor system have so much energy that they directly pass through these cyclotron-stabilizing magnetic fields.

As is the case in the compressor 92, there is three-dimensional control of the trajectory of each charged particle 70 nucleus in the reaction chamber 122. This is provided by the three-magnetic fields (B) with their intensity and shapes, and the paired accelerator coils with the curl of the solenoid field 116, surrounding the reaction chamber, to prevent cyclotron energy losses.

With the magnetic environment in place for ring placement, stability, angular velocity, Larmor radial frequency, and density, there is only one item left to encourage this reaction. That item is magnetic resonance and node formation. As said before, the magnetic moment of the ⁶Li nuclei needs to be aligned. This alignment in ring configuration is provided by the circular magnetic field (B) created by the direct current of the central conductor that rises vertically through the entire Coulomb force neutralized reactor system 45, and the injector field 235, as shown in FIG. 25.

Bringing the nuclei 70 into the reaction chamber 122, controlling the three-dimensional trajectories of these charged particles, and bringing them together at a defined density and energy in the ring configuration does not ensure efficient results. Each nucleus' individual movements must be controlled. These movements track the particles' Larmor radius around the magnetic field (B) lines, following magnetic orientation, and polarity of the field. For the ⁶Li nuclei under the NMR influence, the magnetic attraction between the nuclei, shown by the Bio-Savert Law, to a large extent if not completely, cancels out the electrical repulsion between them, as shown by Coulomb's Law. Both of these laws have in common the square of the distance between the charges. Therefore, the increasing and relativistic linear velocity, mass, and momentum between the ⁶Li nuclei, due the concave solenoid field in the reaction chamber, brings these nuclei together with sufficient density and energy for alpha particles 270 to be produced. Controlling these movements is necessary for reaction because, not only is the density of the ring in the compression chamber not enough for sufficient control of the particles, but also the density of the ring in the reaction chamber is not enough, if only magnetic field (B) geometry is depended on for control. It is a further requirement that the density of particles in the fuel ring 85 due to these control efforts does not inadvertently cause a reaction, or cause a reduction in reaction efficiency.

The density of particles 70 required for reaction is the sum of the magnetic field (B) vector contributions, plus the contributions from node formation, plus the contribution from an increase in reaction cross section due to nuclear magnetic alignment. The perpendicular magnetic field (B) needed to equalize the energy states of the aligned nuclei is provided by adding a pulsed magnetic field (B) to the injector field 235 of the injection coil 215. This pulsed magnetic field (B) again is added to the steady direct current injection magnetic field (B) that has its own stated responsibilities, as shown in FIGS. 21 and 25.

The Larmor precessional frequency resonant pulse is on continuously to give time for the ⁶Li nuclei to respond as the ring transitions from the compressor 92, into the reaction chamber 122. This gives time for each individual nucleus to settle down and find its lowest potential energy position relative to its mass and momentum, charge, and spin. That lowest potential energy place is the alpha particle 270. These positive charges are at a lower potential energy position internally than the two beginning nuclei, but are very energetic as a whole.

IX. Cyclotron Stabilizing Field

As shown in FIG. 24, the cyclotron stabilizing field 224 is not just one field, but is a series of fields in the reaction chamber 122. The composition of this series of fields and coils is the same as described in the accelerator, as shown in FIGS. 5A, 5B, 25, 28A, 34A, 34B, 36A and 36B, in that these field coils have a tear drop shape and field density distribution. Their purpose is the same, which is to add energy to those charges 70 that find themselves to be in this changing magnetic environment, with respect to their position in it. This change of density is consistent within the horizontal (x)-(y) plane of the ring, as well as the (x)-(z) plane of ring rotation.

The volume of this series of cyclotron stabilizing fields 224 surrounds the reaction chamber 122. It is the inner part of the generator. The field is weaker than the general solenoid field 116 of the reaction chamber. This field is parallel to the general solenoid field in the reaction chamber, and can to a small degree, be used to deflect the alpha charges 270 produced, and help make a more efficient use of the reaction products.

X. Control

The device and operation of the present invention presents many opportunities for control of these ⁶Li nuclei charges 70. The device itself is a controlling function, but within the configuration of the device's components there are control necessities, redundancies, and opportunities of control refinement.

The amount of ⁶Li nuclei per unit of time must be controlled. These nuclei 70 are counted in the accumulator 93, and compared with a demand requirement with respect to time. The computed result gives a plus or minus directive to the ablative origin. This directive is also subject to the production of the nuclei at the origin at the time of the directive, and the lag time of the ions in the accelerator 91. The reason for putting the counter in the accumulator and not at the fuel's ablative source is to maintain accuracy. At the source, the ions are not as organized and there is a possibility that ions could be counted incorrectly. This would have multiple effects on the power output, all in departure from the requested energy output.

It is important to control the number of nuclei in the fuel ring 85, and also the number of formed fuel rings per second. Here again, a directive is given to the origin and to the ejector coil 161 of the accumulator 93, to release the sized fuel rings with respect to time.

The counter 144, as shown in FIG. 31, with its computations and directive to the origin and accumulator gate 126 control the size of the fuel ring 85, and thereby the number of fuel rings or the number of nuclei 70 processed per second. These directives are given upon request of outside need.

It is also necessary to control and to regulate the current to the various coils and plates. The amount of direct current first must be enough to contain and form the fuel ring 85 in its expected geometry. This amount is dependent upon the ring radius. Lenz's Law points out that reverse induction must be neutralized in the coils to maintain the stability of field intensity and geometry. The rate of this reverse induction is a pulse in current replenishment that is equal to the rate of the fuel rings 85 or nuclei 70, per second processed. It is also the measure of the amount of work needed to bring the nuclei to the proper, desired density for fusion. The capacity of each pulse is dependent upon the angular velocity and cumulative charge of each fuel ring. These pulses apply to all the coils, the central conductor 140, the accelerator 91, accumulator 93, compressor 92, and the coils in the reaction chamber 122. Any milliamp current drop must be compensated for, in sustaining a constant amperage of direct current to the coils. This current must come from a capacitor that is charged from the generator 125.

This indication of the milliamp induction with the passage of a fuel ring 85 through the reaction chamber 122 is a confirmation of the indication from the counter 144. It is a redundant input of information that can be used for refinement of the directives. The same is the case with the accumulator 93. These are redundant to further refine and control the requirements of these chambers. The summed magnetic field (B) configuration provides opportunities to further refine the trajectories of the charges 70. The magnetic field arrangements in each, the accelerator 91, accumulator, in the compressor 92, and in the reaction chamber, have the same summed conclusion of controls, which is an exact control of the spiral fuel ring. The final summed magnetic field, as experienced by the moving nuclei or charges 70, is a three-dimensional spiral, as shown in FIGS. 33A, 33B, 33C, and 33D. By varying the ratio of the participating coils and vertical conductor, this spiral can have its geometry changed.

The moving nuclei, which are electric particle charges 70, experience these three crossing magnetic fields (B) as additive. These three fields' strength values form a dimensional number or ratio. This ratio should be variable to reflect control on the energy of the fuel ring 85. This ratio, given the manufactured steady state of the coils and the central conductor 140, then is manipulated when a change is executed. The wattage of the conductors is changed to meet the profile of that ratio to meet the need. A “buffer” is an option preferably incorporated into the feed fuel stream 52, with respect to flow, to prevent oscillation or flutter in the Coulomb force neutralized reactor system 45. This feedback and wattage adjustment is an important control of the constant changes that are inherent due to temperature, barometric pressure changes, vibration, and other outside environmental impositions on the entire structure of the Coulomb force neutralized reactor system. These effects change angular velocity, toroidal volume, rate of fuel processing, control of nuclear resident time, energy output, and efficiency. Control of these ratios is not only a necessity of design but also an opportunity for refinement of the charge pathways.

The compressor radial field 119 and the accelerator radial field 117 are created by paired coils 107 with the magnetic field (B), having a flux between the paired coils as shown in FIG. 28A. Each paired coil has an inner coil 146 and an outer coil 147, as shown in FIGS. 7, 28A and 28B. When all the inner coils are arranged in position about the pre-reactor 50, the inner coils form an inner radial coil shell 148, as shown in FIG. 9. Similarly, when all the outer coils are arranged in position about the pre-reactor 50, the outer coils form an outer radial coil shell 149, as shown in FIG. 9 In the accelerator 91, an inner accelerator radial coil shell 54, is preferably utilized as shown in FIGS. 1, 21, 25 and 30. A counterpart outer accelerator radial coil shell 75, is preferably utilized as shown in FIGS. 1, 21, 22A, 22B, 25, 30 and 35. Similarly, in the compressor 92, the inner compressor radial coil shell 57, is preferably utilized as shown in FIGS. 1, 21, 22A, 22B, 25, 30 and 35. A counterpart outer compressor radial coil shell 78, is preferably utilized as shown in FIGS. 1, 21, 22A, 22B, 25, and 35. The inner radial shells form the inner surface of the ring chamber 88 and the outer radial coil shells surround the outer surface of the vacuum vessel 104, as shown in FIGS. 1, 21, 30 and 35.

The curvature of the outside, exterior surface of the total magnetic field (B) is inward, concave toward the central vertical axis 128, in both the compressor 92 and the reaction chamber 122. This curvature acts to increase the upward vector on the ring spiral trajectory as the charges 70 move through this field. As this upward vector increases with respect to the downward vector 213 of the compressor radial field 119, and the injector field 235, the velocity of downward movement of the plane of rotation incrementally decreases as the vertical angular velocity 222 of the spiral incrementally increases due to increasing inward vector force from the central conductor. The charges occupy a declining horizontal block of volume for an increasing amount of time, while having an increasing density. Remarkably, this gives control of nuclear resident time.

Control of the fuel ring 85 in the reaction chamber 122 is accomplished by the downward force of the injector field 235. The injector field is generated by the injector coil 215, and its geometry and value, coupled with the extension of the compressor radial field 119 into the reaction chamber, as balanced by the upward vector of the solenoid flux concentrator 211, and its geometry and value. Control is further strengthened with the stabilization from the cyclotron accelerator coiled pairs 230. This balance controls the vertical movement of the ring while its radius is controlled by the solenoid curl of the field created by the bottom of the compressor radial fields and extension of the general solenoid field 116, through the solenoid flux concentrator field. The circular magnetic (B) field 141 of the central conductor 140 provides stability and alignment of the nuclei. The paired cyclotron coils 230 return energy to restore cyclotron energy losses. With this magnetic environment the ring and its nuclei find a framework of equilibrium.

Control of this framework is a manipulation of ratios of the geometries and amperages of the sources of the magnetic environments. These changes are in real time and are responses to demand changes. The fuel ring 85 compression magnetic field (B) of the reaction chamber 122 is a critical place in the present invention. The placement of reaction of the ⁶Li ions cannot be at any other value than the needed maximum point of ring compression and energy. In an alternative description of this control, the reaction point is the unique place for each fuel ring, where vertical angular velocity of the ring is maximized. The reaction takes place at this maximum density point to give the best opportunity for the alpha charges 270 to enter the generator 125. The curl of the magnetic field (B) in the reaction chamber 122 tapers at the place where the reaction occurs. Furthermore, the Larmor precessional pulse from the injector coil 215 places the reaction in the reaction chamber. With this positioning of the dense ring and the spiral injector coil's pulse, the alpha charges 270 produced from the nuclear reaction enter the generator 125, as shown in FIGS. 33A and 36A.

XI. The Generator

This generator 125 has a unique and functional design. The basic principles of its function are rooted in Maxwell's equations, with emphasis upon induction through Faraday's Law. As has been shown herein, the products of the ⁶Li+⁶Li reaction are the positive charged alpha particles 270, which come streaming out of the reaction chamber 122. Their movement and velocities are determined by both the repulsive natures of their positive charges and their kinetic energy of 20.5 MeV that is a result of the reaction. The direction of this movement is in a three-hundred and sixty degree (360°) disk, as shown in FIGS. 33D, 36A, and 36B. The plane of this disk is ninety degrees (90°) to the central vertical axis 128 of the reaction chamber.

The generator 125 then must be made to take advantage of the characteristics of the alpha particles 270. The alpha particles are pulsed, and each pulse has a specific number of particles, each particle with an individual velocity, charge, and direction of movement that is not uniform. The generator brings together these variables in a vacuum chamber 280, preferably in the shape of a disk with height to give it volume. Inside the vacuum chamber, as shown in FIGS. 36A and 36B, are preferably two, or optionally more, arrangements of the conductors 251, in which current is produced.

As shown in the FIGS. 21, 33D, 36A and 36B, the generator 125 surrounds the reaction chamber 122 and is between the compressor 92 and the solenoid flux concentrator 211. The inner volume of the generator most preferably has the same vacuum as is required throughout the entire structures of the accelerator 91, compressor 92 and reaction chamber 122.

The diameter and height of the generator 125 is determined by the trajectory and the velocity of the alpha charges 270, which are ⁴He nuclei without their two valence electrons. The generator is shown in FIGS. 36A and 36B. As the charges move outward in the generator between the generator conductors 251, their velocity approaches zero (0) and this distance is the generator diameter. The width of the generator again is determined by the trajectories and velocities of the alpha charges.

In a most preferred embodiment of the Coulomb force neutralized reactor system 45 of the present invention, the generator 125 is positioned at the center a pre-reactor pair 250, as shown in FIGS. 23 and 33D, to add efficiency. In this most preferred embodiment, a second pre-reactor 262 is placed beyond the solenoid flux concentrator 211. The two pre-reactors operate independently of each other, in that they are completely out of phase with each other and the fuel ring 85 of the first pre-reactor never contacts the fuels ring of the second pre-reactor.

The generator conductors 251 radiate out from a circular hub similar to spokes in a wheel with the alpha particles 270 moving radially among them. The generator conductors spiral out from the outside of the cyclotron coils 230, and have logarithmic curves in three dimensions with two in the direction of the original ⁶Li nuclei 70 rotation in the fuel ring. This is to improve generator efficiency by keeping the alpha charges in close proximity to the electrodes as they lose velocity. The size of the electrodes is determined by their current carrying capacity. These capacities are well known with respect to heat and resistence.

Each alpha particle 270 is essentially on its own, as were the ⁶Li nuclei before it, each one giving off an electric field. This electric field is moving, creating a magnetic field that is ninety degrees (90°) to the movement of the charges. The magnetic field is circular and radial to the movement of the charges.

Furthermore, the pulse of the alpha charges 270 enters the chamber of the generator 125, the generator conductors 251 experience an increase of electric field and thus an increasing magnetic field which crosses the conductors at 90° to the length of the conductors. The value of the alpha charge's magnetic field (B) is found through a conventional application of the Ampere-Maxwell Law. As the pulse of the alpha charges enters the generator, the magnetic field increases and this changing magnetic field does work on the electrons in the conductors moving them at 90° to the crossing magnetic field. This mechanism operates in accordance to Faraday's Law of Induction. Additionally, because of the unevenness of the movement of the alpha charges, their positions relative to the generator conductors will always be different as they are closer to one conductor than to its neighboring conductor, thus inducing a different current in one conductor relative to another. According to Lenz's Law and the Bio-Savart Law a different reverse electromotive force (emf), one relative to another is created, causing a braking force on the angular velocity of the alpha charges. Energy is conserved, turning kinetic energy into electric current.

After the initial increase in magnetic intensity, the velocity of the alpha charges 270 decreases as just shown, reversing the process of induction through a decrease in magnetic intensity. These reversing changing magnetic fields induce and produce an alternating current in the generator 125. The frequency of this current depends upon the rapidity of the pulse, or fuel rings 85 per second, which is determined by need.

XII. Numerical Conclusions

Each reaction of the ⁶Li charges 70 within the reaction chamber 122, produces an energy release that has a given value (Q). To obtain a reasonable understanding of the positive energy usefulness of the Coulomb force neutralized reactor system 45 of the present invention, an estimate of the net energy output of the reactor system can be made. This net output is the “bottom line” for energy production with the reactor system 45 of the present invention. History has shown that all previous fusion reactor designs have required more energy to produce the controlled fusion reaction than the energy produced by that reaction. The following analysis shows that in the design of the present invention, there can be a net energy gain.

XIIa. Kinetic Energy of the Ring

The total kinetic energy of the fuel ring 85, in the form of acceleration to the final angular velocity of 3.3(10⁶) m/s, is in Joules, with the fuel ring having a radius of 0.18 meters. Using table 1.1 in Section IIa, above, the angular velocity that gives a minimum (Bₜ) value because of the increasing dominance in the sum relative to the centripetal force is 3.3(10⁶) m/s. The equation for kinetic energy in Joules is K=1/2 mv², where (m) is the mass of the ⁶Li nuclei and (v) is the angular velocity. (m) for the ⁶Li nuclei is 9.9(10⁻²⁷) kg and the (v) value is 3.3(10⁶) m/s.
K=0.5[9.9(10⁻²⁷)][3.3(10⁶)]²J
K=5.39(10⁻¹⁴)J
(K) for the entire ring is n[5.39(10⁻¹⁴)]J where (n) is the number of nuclei in the ring. Section IIa, Eq. (4) is n=1.188(10¹³)r, and (r) is the radius of the ring. (r) for this analysis is set to be (0.18) meters. (K) for the entire ring then is:
K=[5.39(10⁻¹⁴)][1.188(10¹³)](0.18)J
K=0.1152 J

XIIb. The Total Potential Energy of the Ring

The total potential energy of the fuel ring 85 is shown in a Table 2.1, and Graph 2.1, of Section IIb, above. As shown in Table 3.1 and also in Section IIb, radius (r) values of the ring fuel along with magnetic field (Bₜ) values in Tesla are related, to manage the ring. Table 3.1 shows the energy (Uₜ) values in Joules and the energy yield values in Joules (Q). The (Uₜ) value is the calculation for the total potential energy of the ring, which is the energy of the Coulomb repulsion across the ring. Looking at the Table 3.1; as (r) increases, (Bₜ) declines, (Uₜ) increases, and (Q) increases.

XIIc. The Energy Required to Operate the NMR System

An appropriate relation for equating electrical field to magnetic field strength is E=2μₚB which can be translated to equating work with the relation E=2μ₆_{_{Li}} B. Since only a single energy state is being changed, the equation becomes E=μ₆_{_{Li}} B. According to Table 1.2, in Section IIa. above, the (B) value being used is (0.8) T. (μ₆_{_{Li}}) is the sum of magnetic moments of all the protons and neutrons in the nucleus. For ⁶Li the value is the sum of the moments times the nuclear magnetron value [5.5(10⁻²⁷)]J/T.
μ₆_{_{Li}}=3(2.7928-1.9135)[5.05(10⁻²⁷)]J/T=
μ₆_{_{Li}}=1.3321(10⁻²⁶)J/T
E=0.8[1.3321(10⁻²⁶)]J
E=1.06568(10⁻²⁶)J

The energy to align the magnetic moments is the (E) value, times one-half the number of nuclei in the ring or n/2. Eq. (4), herein above, shows n=1.188(10¹³)r, where (r) is 0.18 m and therefore:
E_{Total}=0.18[1.188(10¹³)][1.06568(10⁻²⁶)]J
E_{Total}=1.1394(10⁻¹⁴)J
1 MeV=1.602(10⁻³) J and the ⁶Li reaction gives a (Q) value of (20.5) MeV.
Q_{Total}=(0.5)(0.18)[1.188(10¹³)][1.602(10⁻¹³)](20.5)
Q_{Total}=3.511 J

The percentage of energy to operate the NMR component of the present invention is insignificant, relative to the energy produced. The energy cost being 1.1394(10⁻¹⁴) J compared to 3.511 J for each ring fuel unit.

From these calculations can be determined the frequency of the ⁶Li nuclei. The relationship is:
v=μ₆_{_{Li}} B/h (46)
where (v) is the frequency, (h) is Planck's constant of 6.626(10⁻³⁹) Joules/sec and (B) is 0.8 Tesla. Using these values, (v)=16.07 MHz for the ⁶Li nuclei in the Coulomb force neutralized reactor system 45 of the present invention.

XIId. The Lost Energy Cost of Alpha Charges Not Entering the Generator

The lost energy of alpha charges not entering the generator 125 is the largest energy loss, or “cost,” of the entire Coulomb force neutralized reactor system 45. This loss is a function of the geometry of the reactor system. It is assumed that the alpha charges leave the reaction in all directions from the nodes, but that is just an assumption. The alpha charges have a built in momentum from the rotation of the fuel ring 85 in the (x) and (z) dimensions, giving them a propensity to expand outward after reaction. Nevertheless their energy value of 20.5 MeV precludes this initial momentum so that for this work's analysis the assumption of alpha trajectory is equal in all three dimensions.

There are several geometric variables that effect the efficient harvesting of these alpha charges and they need to all be manipulated for the optimum result. These variables are:
The size of the reaction chamber in the (x) and (z) dimensions relative to the radius of the fuel ring 85 at the time of reaction;
The size of the reaction chamber 122 in the (y) dimension relative to the fuel ring radius.
The placement of the reaction in the (y) dimension as a departure from the middle of the chamber;
The geometry of the solenoid flux concentrator 211, at the bottom of the reaction chamber; and
The trade-off between reaction chamber volume and (B) field strength and density to contain the fuel ring.

By manipulating these variables in various combinations it is possible to have an energy cost of between 15% and 35%. For an approximate, conservative estimate of this percentage a choice of 25% is made.

XIIe. The Electrical Resistance Energy Cost

For the Coulomb force neutralized reactor system 45 of the present invention, the electrical resistance energy cost can be estimated as follows: 1 Ampere=1 C/s, where (C) is the electric charge and (s) is time in seconds. If the angular velocity (v) of the ring is 3.3(10⁶) m/s and the radius of the ring (r) is 0.18 meters then the ring has a circumference of 2πr=(1.13) m. The number of times each nuclei circles the ring/second is 3.3(10⁶)/1.13=2.92(10⁶). From the previous findings in section XIIc, above, it is known that the ring with these parameters has an (n) value of 2.1384(10¹²) nuclei. From the nomenclature of Section IIa, above, the charge on the ⁶Li nuclei is 4.8(10⁻¹⁹)C. From these numbers the amperage/second (I) of the ring can be determined.
I=n©₆_{_{Li}})(number of nuclei rotations/s) (47)
I=[2.1384(10¹²][4.8(10¹⁹)][2.92(10⁶)]
I=2.997 amps

According to Lenz's Law, each ring has a back current of (2.997) amps. The resistance in this magnetically summed system is estimated by the length (l) of the wire to be 200 meters with a cross section of 0.025π=0.0785 m². Using the equation:
R=p(l/A) (48)
where (R) is resistance, p is the resistivity coefficient of copper [1.7(10⁻⁸)Ω·m], and (A) is the amperage, the resistance can be calculated.

$$\begin{matrix}R = 1.7 ( {10}^{- 8} ) ( 200 / 0.0785 ) Ω \\ R = 4.331 ( {10}^{- 5} ) Ω \\ P = W = {I}^{2} R\end{matrix} \qquad ( 49 )$$

where (P) is power, (W) is watts in J/s, (I) is the current, and (R) is the resistance.
P=(2.997)² [4.331(10⁻⁵)]J/s
P=3.89(10⁻⁴) J/s
For one (1) second the power energy cost is 3.89(10⁻⁴) J.

XIIf. Minimum Energy Cost Due to Alpha-Alpha Collisions

An energy cost due to collisions between individual alpha charges 270 would first require that such a collision occurs, and second that if the collision occurs, the resulting products do not equal the energy potential of the alpha charges involved in the collision. The alpha nucleus is stable with the quantum “magic numbers” of Z=2 and N=2, and therefore an alpha-alpha cross section is exceedingly small. This reaction is so improbable as to not be listed or considered in the reaction tables.

Any alpha-alpha trajectories that are other than one-hundred and eighty degrees (180°) from one another on the same plane are not considered. The ⁶Li+⁶Li reaction takes place in the ring format and so the only possibility of an alpha-alpha head on collision to take place is in the center of the ring on the same plane as the ring. This is the place of the central conductor. There can be no alpha-alpha collisions.

There can certainly be near misses and glancing passes where the positive charge of the alpha nucleus has an influence on the passing alpha charge's trajectory. Any energy loss due to alpha-alpha collisions is so small it is considered insignificant.

XIIg. The Efficiency of the Reaction

The total potential energy of the fuel ring 85, which reflects the containment of the Coulomb repulsion in Joules includes the energy to operate the NMR system in Joules, the loss of alpha charges that will not enter the generator due to geometric limitations, the energy lost due to magnetic coil inductor resistance, and the energy unavailable due to alpha-alpha resistance. Additionally, the total potential energy of the ring must include a framework of efficiency of the reaction itself and generator efficiency.

Adding all the energy costs to make this reaction work for a preferred Coulomb force neutralized reactor system 45 having a radius for the fuel ring 85 of (0.18) m gives the following result in (J). For this analysis, an (r) value of 0.18 meters is used as a preferred embodiment. The addition of energy consumption per fuel ring includes the following factors:
1. The kinetic energy cost is 0.1152 J.
2. The potential energy cost is 0.4677 J.
3. The energy use for the NMR system is 1.1394(10⁻¹⁴) J.
4. The geometric energy cost of the alpha charges is 0.8778 J.
5. Conductor resistance is 3.89(10⁻⁴) J.
6. The alpha-alpha collision energy cost is insignificant.

The sum of these costs gives a value of 1.4611 J, per fuel ring, and the yield or (Q) value per fuel ring if every pair reacted gives a total value of 3.51126 J per fuel ring at the given radius. The difference between these two values is a net energy gain of 2.05016 J or a net gain of 58.388%.

One of the important realizations of the present invention, as discussed above, is that the entire fuel ring 85 must react at the same time for this to work at all. Uncertainty of velocity and position without the use of frequency and wavelength would assure the destruction of the fuel ring due to random fusion events within the fuel ring ⁶Li. Therefore, if the fuel ring 85 reacts as a unit, its efficiency must approach one hundred percent (100%), otherwise it will function well below nominal levels with a very small energy output (Q) value. To be conservative a ninety percent (90%) reaction is chosen. The efficiency of the generator is a matter of effort by those skilled in the field of such optimizations and is not included here.

If a reaction rate of 90% is used then the net (Q) per fuel ring is determined.
0.90(Q_{Total})J−Total energy cost=Net energy production in Joules
0.90(3.51126)J−1.4611 J=1.699 J This gives an efficiency of 48.387%.

The geometry of the Coulomb force neutralized reactor system 45 will give an improved efficiency as the radius of the fuel ring 85 increases within the limits of practicality.

Now some interesting numerical conclusions can be made with respect to net yields varying fuel rings 85 per second, and fuel ring radius. With these numbers fuel consumption can be calculated. Keeping the fuel ring radius at 0.18 m and processing 2.5(10⁶) fuel rings per second at the calculated efficiency gives a net power output of 4.247 MW. If the fuel ring radius is increased to 0.26 m then the net power output increases to 6.25 MW.

If the radius of the fuel ring 85 is increased to (0.5) m some further interesting results are found. Using the nomenclature and Eq. (32), above, the (B_{T}) value is 0.2793 T. This is a very reasonable magnetic field strength. That is the total field that is divided by the number of conductors and coils so each one is a fraction of that total.

With the help of the calculation procedures in the above section the (Q_{T}) can be found at a given radius. For a radius of (0.5) m the (Q_{T}) value is 9.75377 J per fuel ring 85. If the net power output is set at 40 MW then at this fuel ring radius there are [4.1(10⁶)] fuel rings processed per second. Using Avogadro's constant 6.022(10²³), fuel consumption can be found. Keeping the net power output at 40 MW and the fuel ring radius at 0.5 m there are 21.041 grams of ⁶Li used each day.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A system for a fusion reactor comprising:
a fuel ring, the fuel ring including a charged particle, the charged particle having a controlled spiral trajectory, the fuel ring rotational with respect to the controlled trajectory of the charged particle;
the controlled spiral trajectory of the charged particle within the fuel ring described by a Larmor radius;
the controlled spiral trajectory of the charged particle bounded within a magnetic field; and
a reaction chamber formed by the magnetic field.

2. The system for a fusion reactor system of claim 1, wherein the magnetic field exerts a force of constant origin on the charged particle, and the magnetic field exerts a pulsed force on the charged particle; and
a nuclear magnetic resonant control of the charged particle within the reaction chamber provided by the combination of the force of constant origin and the pulsed force.

3. The system for a fusion reactor system of claim 1, wherein the magnetic field forms a plurality equidistant nodes, each equidistant node including one of the charged particles.

4. The system for a fusion reactor system of claim 1, wherein the sum of magnetic fields includes a vertical conductor along the center of the nuclear reaction chamber.

5. The system for a fusion reactor system of claim 1, wherein the Larmor radius describes a spiral path trajectory for the charged particle;
the position of the charged particle describable by a wave function;
the wave function includes a guiding center;
and the guiding center approximates the spiral path trajectory; and
the fuel ring contains the charged particle.

6. The system for a fusion reactor system of claim 1, wherein the fuel ring includes a plurality of charged particles;
the plurality of charged particles counted in an accumulator; and
the accumulator for regulating a feed of the charged particles into the fuel ring, and the accumulator for controlling a fusion reaction rate.

7. The system for a fusion reactor system of claim 6, wherein a control of a resident time within the fuel ring is provided by a compression of the fuel ring; and
the compression of the fuel ring defined by the plurality of charged particles occupying a declining horizontal block of volume, and the plurality of charged particles have an increasing density,

8. The system for a fusion reactor system of claim 7, wherein the ring compression is dependent upon an external curve of the reaction chamber, the external curve of the reaction chamber having a concave curvature in relation to a central axis of the reaction chamber.

9. A system for a fusion reactor comprising:
a fuel ring, the fuel ring comprising a plurality of charged particle;
a magnetic field coil for generating a multiple element magnetic field;
the multiple element magnetic field for concentrating and confining the fuel ring within the fusion reactor, and each element of the multiple element magnetic field having a field strength value;
the field strength value for each element of the multiple element magnetic field variable in magnitude, to control the fuel ring;
the fusion reactor includes an accelerator, the accelerator for accelerating the plurality of charged particle in the fuel ring, and the fuel ring within the accelerator having a form of an expanding spiral; and
the fusion reactor includes a compressor, the compressor for compressing the plurality of charged particle in the fuel ring with the multiple element magnetic field, and the fuel ring within the compressor having a form of a declining spiral.

10. The system for a fusion reactor system of claim 9, wherein the fusion reactor includes a generator, and the generator recovers a fusion product and generates electricity.

11. The system for a fusion reactor of claim 9, additionally comprising a plasma generator, the plasma generator for generating the fuel ring.

12. The system for a fusion reactor system of claim 11, wherein:
the accelerator receives the fuel ring from the plasma generator;
the compressor focuses the fuel ring into a reactor chamber; and
the reactor chamber contains a fusion reaction of the plurality of charged particle of the fuel ring.

13. The system for a fusion reactor of claim 12, wherein:
the fusion reactor includes a central axis, and the accelerator includes an accelerator exterior, and the accelerator exterior includes an inward surface curve, the inward surface curve depressed toward a central axis; and
the fuel ring proximately follows the inward surface curve of the accelerator.

14. The system for a fusion reactor system of claim 12, wherein:
the fusion reactor includes a central axis, the compressor includes a compressor exterior, and
the compressor exterior includes an outward surface curve, the outward surface curve distended away from the central axis; and
the fuel ring proximately follows the outward surface curve of the compressor.

15. The system for a fusion reactor of claim 12, wherein:
the fusion reactor includes a polar axis, the polar axis oriented normal to a central axis of the fusion reactor, and the multiple of magnetic fields including an outer curve;
the outer curve of the magnetic fields directed along the polar axis from the central axis within the reactor;
a spiral ring trajectory formed at the outer curve, for containing the fuel ring, the fuel ring introduced into the reactor at a fuel ring inlet; and
an upward vector of magnetic field force formed on the ring spiral trajectory as the charged particle of the fuel ring move through the magnetic field, the upward vector of magnetic field force directed parallel to the central axis, toward the fuel ring inlet of the reactor.

16. The system for a fusion reactor of claim 15, wherein:
the fuel ring moves in a plane of rotation, the plane of rotation proximately parallel to the polar axis of the reactor, and each of the multiple of magnetic fields includes a magnetic field force vector; and
a resultant vector sum of the multiple of magnetic field force vectors causes the plane of rotation to move toward the reaction chamber.

17. The system for a fusion reactor of claim 16, wherein:
the plane of rotation to moves toward the reaction chamber at a velocity of downward movement, and the magnitude of velocity of downward movement of the plane of rotation incrementally decreases as the vertical angular velocity of the ring spiral trajectory incrementally increases.

18. A lithium fueled system for a fusion reactor comprising:
a fuel ring, the fuel ring comprising lithium nuclei;
a reactor for converting the lithium nuclei of the fuel ring into alpha particles by a nuclear fusion reaction;
a magnetic field coil for concentrating and confining the fuel ring within the reactor; and
a generator for recovering fusion products from the reactor.

19. The lithium fueled system of claim 18, additionally comprising:
a plasma generator for generating the fuel ring.

20. The lithium fueled system of claim 18, wherein the generator generates electricity.
